(19) United States
(12) Patent Application Publication
(10) Pub. No.: US 2022/0091080 A1
(43) Pub. Date: Mar. 24, 2022

(54) GAS AND/OR CHEMICAL LIQUID INDICATOR

(71) Applicant: NITTO DENKO CORPORATION, Osaka (JP)

(72) Inventors: Koichi Nakamura, Rockledge, FL (US); Nahid Mohajeri, Rockledge, FL (US)

(73) Assignee: NITTO DENKO CORPORATION, Osaka (JP)

(21) Appl. No.: 17/423,996

(22) PCT Filed: Jan. 17, 2020
(86) PCT No.: PCT/US20/14213

§ 371 Date: Jul. 19, 2021

Related U.S. Application Data
(60) Provisional application No. 62/794,322, filed on Jan. 18, 2019.
(60) Provisional application No. 62/899,669, filed on Sep. 12, 2019.

(51) Int. Cl. G01N 31/22; G01M 3/04

(52) U.S. Cl. CPC G01N 31/224; G01M 3/04

(57) ABSTRACT

Described herein is an ammonia compound indicator comprising an adhesive and a chemochromic compound disposed therein. Also described are methods of making the aforedescribed elements and methods for indicating the presence of ammonia.

### RELATED APPLICATIONS

This application claims the benefit of U.S. Provisional Patent Application Ser. No. 62/794,322, filed Jan. 18, 2019, and U.S. Provisional Patent Application Ser. No. 62/899,669, filed Sep. 12, 2019, the disclosures of which are incorporated herein in their entirety by reference.

### FIELD OF THE INVENTION

The disclosed embodiments relate to an indicator for detecting leaks of ammonia gas and/or liquid from joint part of pipes, flanges, leak port, and methods for manufacturing and using of said indicator.

### BACKGROUND OF THE INVENTION

Ammonia is a caustic and hazardous compound when used in high concentrations. Any leakage of ammonia gases and liquids can create fatal incidents due to its high flammability and health effects on workers' lungs. Gas leaks are more dangerous than liquid leaks since the majority of gas leaks cannot be observed by the naked eye. Ammonia gas has been used for fertilizer. In the off season, remaining ammonia gas is kept in tanks and periodic checks to find any leaks is required. Also, ammonia gas is used for ice making for rinks and refrigeration for agricultural goods and their processing plants.

Typically, a gas leak is detected when its pressure drops in the pipeline, there is an unusual consumption rate, and/or by using area gas sensors. Also, area by area or room by room, area gas sensors may be installed. These may indicate some gas leak exists somewhere in certain areas. However, it is not helpful with finding the exact location of a leak that may be at a flange, leak port, valve, or connection to gauges. Hence, to determine the exact leak location, the operator needs to check each individual joint part one by one with a handy sensor, soapy water, sulfur stick, or litmus paper. After major maintenance has been carried out, leak tests need to be performed carefully. In general, it takes a long time to find the exact leak location and as a result, operation time may be lost.

To find out the exact leak location, in case of ammonia gas, sulfur sticks have been used for gas leak detection. However, to use a sulfur stick, the stick needs to be ignited. Since ammonia gas is a flammable gas, having an open flame during the stick's ignition and during the stick's usage is not a safe activity. Another method to detect ammonia gas leaks is using litmus paper. When litmus paper is used, it needs to be wet. Therefore, once it starts drying out, the operator can't differentiate between a no gas leak or non-detectable situations. In some cases, since pH dyes are too sensitive, the color of pH dyes often changes by just stepping in an area before identifying where exact leak location is. The use of handy sensor is influenced by wind and distance. Soapy water may be difficult to apply if you want to check large flanges, inverted places, or areas close to the wall. Both sensors and soapy water techniques require special skills to be used effectively.

Using the above-mentioned methods, the existence of leaks can be recognized relatively easy. However, it is more challenging to find the exact location of the leak. Furthermore, they are all reactive responses to a leak situation.

Wrapping joint parts on pipes with a gas detection tape whose color can be changed when a gas leak occurs is a more ideal way of detection. Since wrapping creates a confined space between the pipe and the tape, the leaking gas can accumulate at higher concentrations at that area. This makes detection by tape easier than other conventional methods in the art. Furthermore, the detection tape can provide long term monitoring of surfaces prone to leak development.

In the case of ammonia gas, several products, listed in Table 1, are available in the market (ammonia detection tape, Pacific Sentry, USA; ammonia detection cloth, Precision Laboratories, UK; TAL-4 NIT Safety, Korea; BT-50 SMTEK, Korea). Also, WO2017/209366 discloses adding pH dyes in a silicone adhesive to make an ammonia leak detection adhesive tape. US Pat. Pub. No. 2008041136 discloses using a pH dye like bromophenol blue, congo red, etc. as an ammonia gas monitor. U.S. Pat. Nos. 3,528,780 and 7,592,184 disclose ammonia gas sensors utilizing pH dyes. These prior art technologies utilize pH dyes whose color can change when it contacts gases because of the change in its pH. Bromo thymol blue, bromo cresol green (BCG), thymol blue, phenol red, bromophenol red, chloro phenol red, etc. are commonly used as chemochromic (color-changing) materials in the art.

Although the detectable chemical is different from that of the present invention, U.S. Pat. No. 5,529,841 discloses a field test kit that can detect hydrogen sulfide in liquid. In this kit, lead acetate, copper sulfate, copper thiocyanate, and silver nitrate are described as colorimetric particulates that change color when they are exposed to hydrogen sulfide. This colorimetric particulate is covered by silicone barrier film or it is dispersed in silicone barrier film that is in solid form. Copper sulfate is dissolved in water and spread on plastic film or on filter paper. In cases where a colorimetric particulate is added into a silicone polymer, it is directly mixed with the silicone polymer in a liquid hydrocarbon like hexane or xylene.

U.S. Pat. No. 9,958,397 describes an exemplary process for sensing a toxic chemical, which includes contacting a toxic chemical with a sorbent that includes a porous metal hydroxide and a transition metal reactant suitable to react with a toxic chemical.

The instability of pH dyes makes it difficult to use in the harsh conditions of actual industrial applications. pH dyes are easily decomposed by UV light and therefore are not suitable for outdoor applications on ammonia gas pipelines. In the case of pH dye, when ammonia gas is present, color change can occur. However, if the flow of ammonia gas is stopped, the color reverses back immediately. This is not useful for practical purposes. If a gas leak is recognized by its smell or by pressure drop in a pipeline, best practice is for the gas flow to be stopped immediately. At that time, if the color-change disappears, then the exact location of the leak cannot be recognized. In the case of existing products available in the market as shown in Table 1, all color-change reverted back to the original color right after the product was no longer exposed to the gas.

TABLE 1
Current Chemochromic Ammonia Detection Technologies

| | | | Reversible (reverted |
|---|---|---|---|
| | | Existence | back to original |
| | | of pH | color after ammonia |
| Manufacturer | Product name and type | dye | gas is gone) |
| Pacific Sentry | Ammonia detection | yes | yes, immediately |
| (USA) | tape, PTFE pipe tape | | |
| Precision | Ammonia detection | yes | yes, immediately |
| Laboratory | cloth | | |
| (UK, USA) | | | |
| NIT Safety | TAL-4, | yes | yes, immediately |
| (Korea) | pH paper, both sides | | |
| | have double coated | | |
| | tape | | |
| SMTEK | BT-50 | yes | yes, immediately |
| (Korea) | | | |

### SUMMARY OF THE INVENTION

This invention provides a chemochromic ammonia gas and/or liquid indicator that can be used outdoors or indoors wherein the color-change can be retained for a sufficient amount of time for a user to find the exact location of a leak.

These indicators are pressure sensitive adhesive (PSA) tapes or self-fusing adhesive tapes that can be wrapped and adhered on pipe joint parts like flanges, connection parts, leak ports, valves etc.

A chemochromic indicator for detecting an ammonia compound is described, wherein the indicator can comprise a first adhesive layer. In some aspects, the indicator can comprise a chemochromic copper compound, wherein the copper compound can be disposed in the adhesive layer. In some aspects, exposure of the indicator to an ammonia compound changes the color of the adhesive layer and/or the chemochromic compound contained therein. In some aspects the ammonia compound can be ammonia gas, hydrous ammonia liquid and/or combinations thereof. In some aspects, the adhesive layer can be a pressure sensitive adhesive layer or a self-fusing adhesive layer. In some aspects, the adhesive layer can comprise a silicone polymer, an acrylic polymer, a urethane polymer, a natural rubber, a synthetic rubber, and/or combinations thereof. In some aspects, the adhesive layer can comprise a silicone polymer and/or acrylic polymer. In some aspects, the copper compound can be copper sulfate (CuSO₄), copper nitrate (CuNO₃), copper chloride (CuCl₂), and/or copper acetate (Cu(CH₃COO)₂). In some aspects, the copper compound can be CuSO₄ and CuCl₂. In some aspects, the copper compound can be CuSO₄. In some aspects, the copper compound can be anhydrous or hydrate, or combinations thereof. In some aspects, the indicator can further comprise a contrasting color compound. In some aspects, the contrasting color compound can comprise titanium dioxide (TiO₂). In some aspects, the amount of CuSO₄ can be equal to or higher than 5 parts per 100 of the adhesive. In some aspects, the thickness of the adhesive layer can be equal to or higher than 30 micro meters thickness. In some aspects, the amount of CuSO₄ can be equal to or higher than 10 parts per 100 of adhesive and the thickness of the adhesive layer can be equal to or higher than 30 micro meter thickness. In some aspects, the amount of CuSO₄ can be equal to or higher than 10 parts per 100 of organic polymer or adhesive solid part and thickness of organic polymer or adhesive layer is equal to or higher than 40 micro m thickness. In some aspects, the indicator can further comprise a backing layer. In some aspects, the indicator can further comprise a release liner. In some aspects, the indicator can further comprise a second adhesive layer. In some aspects, the chemochromic indicator can have an adhesion higher than 0.5 N/25.4 mm.

In some aspects, a method for indicating the presence of ammonia gas is described, wherein the method can comprise contacting ammonia with an adhesive layer comprising a chemochromic indicator described above. In some aspects, indicating the presence of ammonia gas is described, wherein the method can comprise determining a difference between a post-exposure colorimetric state of the chemochromic indicator and a pre-exposure colorimetric state of the chemochromic indicator. In some aspects, the copper compound can be copper sulfate. In some aspects, the adhesive layer can comprise a contrasting color compound.

In some aspects, a method for manufacturing a chemochromic indicator is described, wherein the method can comprise dispersing hydrous or anhydrous CuSO₄ in an organic solvent to create a dispersion. In some aspects, a method for manufacturing a chemochromic indicator is described, wherein the method can comprise sonicating the dispersion so as to create a copper slurry. In some aspects, a method for manufacturing a chemochromic indicator is described, wherein the method can comprise adding the copper slurry to a polymer so as to create a mixture. In some aspects, a method for manufacturing a chemochromic indicator is described, wherein the method can comprise coating the mixture onto a backing layer or release liner for drying and curing. In some aspects, a method for manufacturing a chemochromic indicator is described, wherein the backing layer can comprise polyethylene terephthalate (PET). In some aspects, a method for manufacturing a chemochromic indicator is described, wherein the release liner can be a fluorocarbon release liner.

### BRIEF DESCRIPTION OF THE DRAWINGS

FIG. 1 is a side cross section of an aspect described herein.

FIG. 2 is a side cross section of another aspect described herein.

FIGS. 3(a-e) show the trend of adhesive thickness & CuSO₄ loading amount vs. color retention time in case of platinum catalyst curing silicone adhesive. Loading amount is indicated by percentage as follows: (3a) with 3 parts CuSO₄, (3b) with 5 parts CuSO₄, (3c) with 10 parts CuSO₄, (3d) with 20 parts CuSO₄, and (3e) with 25 parts CuSO₄. The ΔL_{differences} of adhesive specimens with a thickness of 20 mm, 30 mm, and 40 mm were measured at initial time (i.e. at zero hours) and over time.

FIGS. 4(a-e) show the trend of adhesive thickness & CuSO₄ loading amount vs. color retention time in the case of acrylic adhesive. Loading amount is indicated by percentage as follows: (4a) with 3 parts CuSO₄, (4b) with 5 parts CuSO₄, (4c) with 10 parts CuSO₄, (4d) with 20 parts CuSO₄, and (4e) with 25 parts CuSO₄. The ΔL_{differences} of adhesive specimens with a thickness of 20 mm, 30 mm, and 40 mm were measured at initial time (i.e. at zero hours) and over time.

FIGS. 5(a-d) show the trend of adhesive thickness & CuSO₄ loading amount vs. color retention time in the case of BPO curing silicone adhesive. Loading amount is indicated by percentage as follows: (5a) with 5 parts CuSO₄, (5b) with 10 parts CuSO₄, (5c) with 20 parts CuSO₄, and (5d) with 25 parts CuSO₄. The ΔL_{differences} of adhesive specimens with a thickness of 30 mm, 40 mm, and 50 mm were measured at initial time (i.e. at zero hours) and over time.

FIG. 6 shows the adhesion to steel (SUS 304) of silicone adhesive at 30 min. dwell time and pulling speed of 300 mm/min. Here, parts per 100 adhesive solid part means weight ratio of anhydrous CuSO₄ against solid part weight of adhesive. For instance, if 2 g of anhydrous CuSO₄ is added in 20 g of adhesive that is 40% solids, then the amount of added CuSO₄ is 25 parts (anhydrous CuSO₄ weight/(adhesive weight×solid %/100)/100)=2/((20×0.4)/100)).

FIG. 7 is a side cross section of another aspect described herein.

### DETAILED DESCRIPTION OF THE INVENTION

It was recognized that organic pH dyes do not have color-change retention property and/or UV stability. A certain amount of time is required to find the exact leak location and hence it is highly desirable for the indicator to retain its color-change even if the gas flow has been stopped. Since ammonia gas or liquid line is often located in an outdoor environment, the indicator needs to be UV resistant. Copper compounds are suitable as chemochromic pigments where their color changes when exposed to ammonia gas (anhydrous ammonia) or liquid ammonia (aqueous ammonia). Especially, CuSO₄ (copper sulfate) provides obvious color-change and enough color-change retention time. Since CuSO₄ is an inorganic material, it also provides greater stability under UV. CuSO₄ is also relatively easy to be added into an adhesive system, especially in a solvent base adhesive system.

By using a colorimeter, the chromaticity of a standard whiteboard is measured. Furthermore, the chromaticity before using the gas detection element is measured. Note that the chromaticity is expressed by the lightness index of the L*a*b* color system (CIELAB1976). The absolute value of the difference is the measured chromaticity between the standard whiteboard and the gas detection element. This value is reported as “ΔL” or “Ab” for before and after exposure to the ammonia gas.

From the above results the color-change of the gas detection element can be evaluated by the following equations:

$$Δ {L}_{difference} = \vert Δ {L}_{after} - Δ {L}_{before} \vert or$$

$$Δ {b}_{difference} = \vert Δ {b}_{after} - Δ {b}_{before} \vert$$

Various copper compounds that may provide color-change by ammonia are tested. To recognize color-change with the naked eye on various surfaces, ΔL_{difference} (color difference between before and after exposed to ammonia, blackness or whiteness) or Δb_{difference} (color difference between before and after exposed to ammonia, yellowness or blueness) need to be about 5, preferably about 10.

In some aspects, a chemochromic indicator is described, wherein the indicator can comprise an adhesive layer. In some aspects, the indicator can comprise a copper compound. In some aspects, the indicator can comprise a contrasting color compound. In some aspects, the indicator may provide a change in the chemochromic state upon contact with ammonia. In some aspects, the chemochromic indicator can provide a change in the chemochromic state.

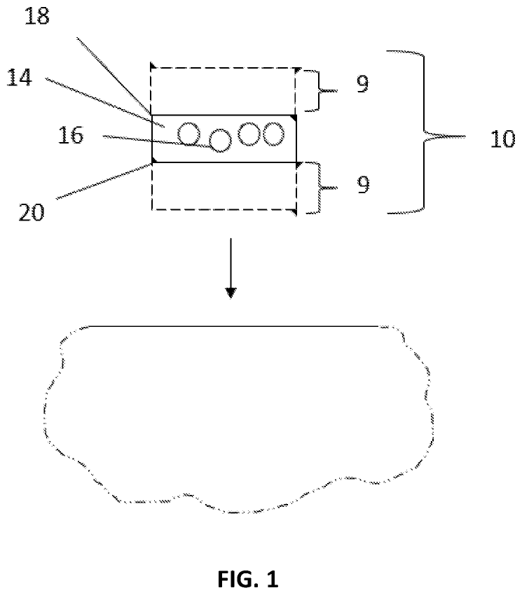

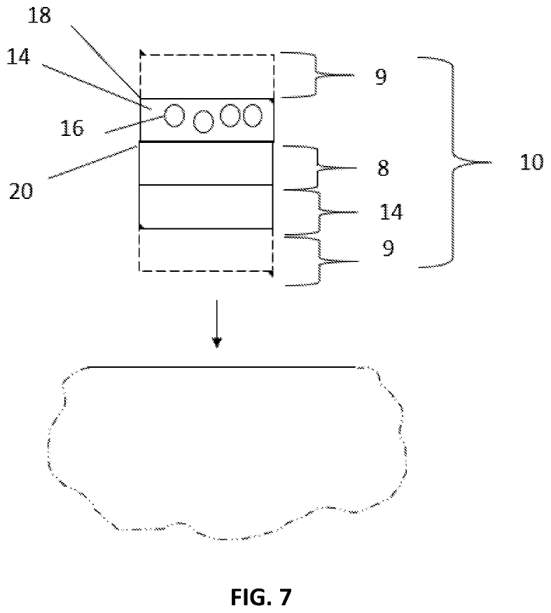

In some aspects, as shown in FIGS. 1, 2, and 7 a chemochromic indicator 10 for detecting ammonia compound is described. In one aspect, the chemochromic indicator 10 can comprise an adhesive layer 14 described herein. In some aspects, the adhesive layer 14 can comprise a first side 18 and a second side 20. The chemochromic indicator 10 can comprise a chemochromic copper compound 16. The adhesive layer 14 can be disposed adjacent to one side of a backing layer 8 for monitoring or indicating the presence of ammonia adjacent thereto. In some aspects, a primer may be added between the adhesive layer 14 and the backing layer 8. The indicator 10 can be applied, disposed, and/or located adjacent the surface of a substrate 30 and/or monitoring location. The substrate 30 can be a conduit transporting a medium containing ammonia therethrough. In some aspects, the adhesive layer 14 can be comprised of the chemochromic copper compound 16 described herein, and the adhesive layer 14, wherein the chemochromic copper compound 16 can be disposed within the adhesive layer 14. In some aspects, a color contrasting compound, e.g., titanium dioxide, can be disposed within the adhesive. In some aspects, the chemochromic indicator 10 can comprise a backing layer 8, wherein the first side 18 of the indicator 10 is disposed adjacent to one side of the backing layer 8. In some aspects, the chemochromic indicator 10 can include a release liner 9 disposed adjacent to the second side 20 of the adhesive layer 14. In some aspects, there may be a plurality of adhesive layers 14, wherein a layer 14 is disposed adjacent to each side of a backing layer 8. In some aspects, there may be a plurality of release liners 9 disposed adjacent to a side of an adhesive layer 14. In some aspects where one or more release liners 9 are used, the liners 9 are removed before application of the chemochromic indicator 10 onto a substrate 30.

In some aspects, the thickness of the adhesive layer 14 can be equal to or higher than 30 micro meters. In some aspects, the thickness of the adhesive layer 14 can be equal to or higher than 40 micro meters.

The structure of the ammonia gas detection indicator as shown in FIGS. 1, 2, and 7 is described below:

Copper Compounds

In some aspects, the chemochromic indicator can comprise a chemochromic copper compound. In some aspects, the chemochromic copper compound can comprise copper sulfate, copper chloride, copper nitrate, copper acetate and/or mixtures thereof. In some aspects, the copper compound can comprise copper sulfate and/or copper chloride. In some aspects, the copper compound can comprise copper sulfate. In some aspects, the copper compound can be anhydrous. In some aspects, the copper compound can be a hydrate. In some aspects, the copper compound can be combinations of an anhydrous compound and a hydrate. In some aspects, the copper sulfate can comprise anhydrous copper sulfate. In some aspects, the copper compound can be between 1-50 wt % of the copper compound. In some aspects, the copper compound can be 1-50 parts, e.g., between 3-25 parts copper compound. In some aspects, the amount of CuSO₄ can be equal to or higher than 5, 10, 20 and or 30 parts per 100 of the adhesive. In some aspects, e.g., copper sulfate, exposure or contact of the copper compound with the ammonia gas, vapor or liquid can result in the formation of tetraamine copper sulfate (II), providing a color change.

In some aspects, the indicator can change to a visually distinct material, e.g., blue or violet, upon exposure to at least 50 ppm, 100 ppm, 150 ppm, 200 ppm, 250 ppm and/or 500 ppm ammonia in an ambient environment or air (e.g., upon exposure to 110 mL/minute flow rate).

In some aspects, the indicator can maintain a visual change, e.g., at least 50%, 75%, 90% of the initial color change to blue or violet, for a period of at least 12 hours, 24 hours, 48 hours, 120 hours, 168 and/or 240 hours upon exposure to at least 50 ppm, 100 ppm, 150 ppm, 200 ppm, 250 ppm and/or 500 ppm ammonia in an ambient environment or air (e.g., upon exposure to 110 mL/minute flow rate).

Adhesive (Polymer)

In some aspects, the chemochromic indicator can comprise an organic polymer layer. In some aspects, the organic polymer can be an adhesive. In some aspects, the adhesive can be a pressure sensitive adhesive. In some aspects, the adhesive can be a pressure sensitive adhesive tape. In some aspects, the copper compounds, especially copper sulfate, are disposed within an adhesive to create a chemochromic indicator that can detect an ammonia gas/liquid. The polymer can be comprised of natural rubber, synthetic rubber, polyurethane or urethane polymer, silicone polymer, acrylic polymer and/or combinations thereof. Suitable tacky adhesives include, e.g., in some aspects, the adhesive layer can be comprised of a non-tacky material. In some aspects, the adhesive can be a self-fusing tape. In some aspects, the self-fusing tape or self-amalgamating tape can be a non-tacky silicone-rubber, ethylene propylene rubber (EPR) tape and/or polyisobutylene (PIB) rubber tape, e.g., 3M self amalgamating tape, 23 Linered Premium Rubber (EPR) and 130C Linerless Premium Rubber tape (Scotch brand tape, 3M brand tapes, 3M, St. Paul, Minn.). In some aspects, the indicating layer can comprise a tacky pressure sensitive adhesive layer. One skilled in the art can determine a suitable pressure sensitive adhesive. A suitable pressure sensitive adhesive can be those PSA adhesives known in the art

The kinds of adhesive and crosslinking system do not have to be limited, but conventional knowledge needs to be applied. For instance, if alcohol is used in the adhesive formulation, isocyanate cannot be used as a cross-linker. To cover a variety of applications, the use of silicone based or acrylic based adhesives is preferred. Silicone adhesives provide UV resistance, acid resistance, and/or alkaline resistance. Acrylic adhesives can be designed for specific applications with relative ease. In some aspects, the silicone adhesive can be an aryl and/or aliphatic substituted silicon polymer, e.g., a methyl phenyl and/or a dimethyl silicon polymer (KR3700 (Shin-Etsu, Tokyo, Japan)). In some aspects, the acrylic adhesive can be EXK18-052 (Toyo Ink, America; East Rutherford, N.J., USA). In some aspects, the adhesive can be an silicon adhesive such as MOM.PSA518 (Momentive Performance Materials, Inc, Waterford, N.Y., USA). In some aspects, the polymeric material can comprise a noble metal or noble metal ion. In some aspects, the noble metal can be platinum. In some aspects, the noble metal can be 0.0001 wt % to about 0.01 wt % of dry parts of silicone.

In some aspects, the indicating layer can comprise a contrasting color compound. While not wanting to be bound by theory, it is believed that the opacity of the contrasting color compound aids in the visual perception of the chemochromic color change. In some aspects, the color contrasting compound can comprise a white pigment or compound, e.g., barium sulfate (PW5/BaSO4), lithopone (BaSO4.ZnS), zinc oxide (PW4/ZnO), silica (SiO₂), aluminum oxide (Al₂O₃), zirconium oxide (ZrO₄) and/or titanium oxide (PW6/TiO₂). In some aspects, the color contrasting compound can be a transition metal oxide. In some aspects, the transition metal oxide can be a Group 4 transition metal oxide comprised of oxides of titanium, zirconium, hafnium, rutherfordium (Ti, Zr, Hf, Rf), or mixtures thereof. In some aspects, the transition metal oxide can be rutile. In some aspects, the transition metal oxide can be anatase. In some aspects, the transition metal oxide can be titanium dioxide (TiO₂) and/or zirconium oxide (ZrO₄). In some aspects, the substantially white pigment can comprise titanium oxide and/or barium sulfate (titanium white). In some aspects, the chemochromic compound, e.g., copper sulfate can change to tetraamine copper (II) sulfate upon contact and/or exposure with an ammonia compound. In some aspects, the ammonia compound can be gaseous, e.g., an ammonia gas and/or ammonia vapor, liquid, e.g., an aqueous solution of ammonia and/or pure liquid ammonia and/or solid. In some aspects, the ammonia compound can be ammonia gas/vapor, hydrous ammonia liquid and or combinations thereof.

Adhesion of the Chemochromic Indicator

In some aspects, the chemochromic indicator can have an adhesion to the substrate or desired monitoring location of higher than 0.1 N, 0.25N, 0.5N, 0.75 N, 1.0 N, 5 N, 10 N and/or 20.0 N/25.4 mm.

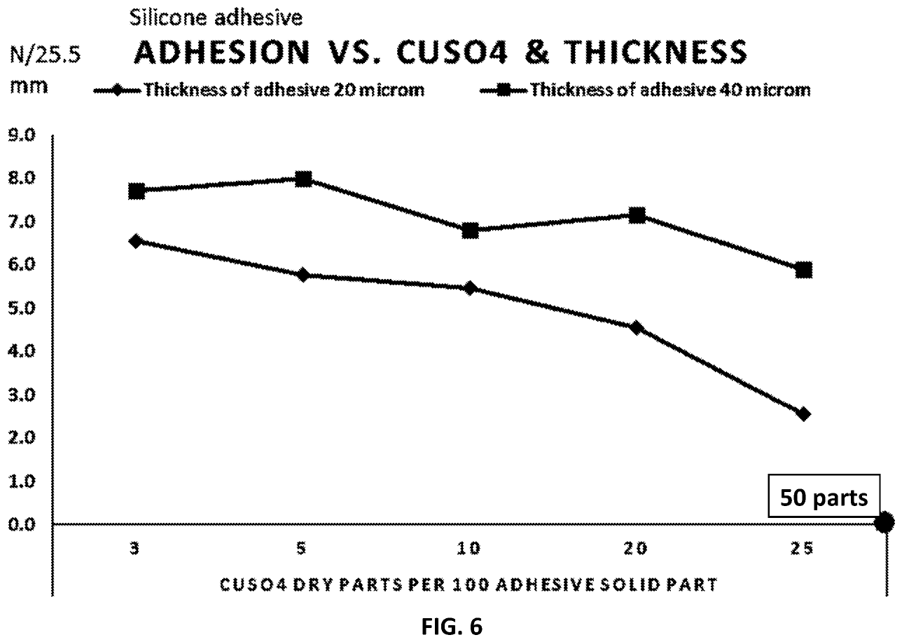

Table 27 and FIG. 6 show adhesion vs. anhydrous CuSO₄ loading amount and thickness of silicone based adhesive indicator layer based on formulation Table 26. When 50 parts of CuSO₄ per 100 adhesive solid part were added, the indicator layer lost tackiness and adhesion completely.

In the case of a solvent-base adhesive, 100 mm is higher than typical thickness which is restricted by solvent evaporation. Without CuSO₄ and TiO₂, adhesion to stainless steel was 25.0 N/25.4 mm. When 5 parts TiO₂ per 100 dry adhesive parts were added, adhesion was 22.3 N/25.4 mm at 100 mm thickness.

The same result was observed with an acrylic based adhesive (Table 29). When CuSO₄ 50 parts per 100 dry adhesive solid part is added, the sample's adhesion was completely lost. In general, to wrap pipes or flanges, about 0.5 N/25 mm of adhesion is required at a minimum in order for the indicator to stay on the substrate. If too much CuSO₄ is added, the adhesive of the indicator may lose adhesion. Adhesion can be adjusted by formulating the adhesive with a tackifier or softener. However, when adhesion is adjusted with a tackifier or a softener, the curing level needs to be adjusted to minimize the adhesive residue when the indicator is peeled off.

The chemochromic indicator can be comprised of a pressure sensitive adhesive layer or self-fusing adhesive layer. A pressure sensitive adhesive layer maybe preferable because it can be applied on the hole of a leak port easier. A leak port is designed for checking gas leaks. If a leak occurs, gas comes to the hole (example: R Swagelock VCR fitting). If a self-fusing adhesive is utilized, the leak port block itself needs to be wrap with the backside of self-fusing adhesive layer. The chemochromic indicator is expected to be removed and replaced when it there is a color-change or after specific period of time once it is applied. If the pressure sensitive adhesive is used then the adhesive layer must be laminated with a backing film, otherwise it will be difficult to remove the tape from the substrate.

Backing Film Layer

In some aspects, the chemochromic indicator can comprise at least one backing layer. In some aspects, the chemochromic indicator can comprise one backing layer. In some aspects, the chemochromic indicator can comprise plural backing layers. In some aspects, the at least one, one or plural backing layers can be disposed on the first side or second (opposite) side of the adhesive layer with the copper chemochromic compound therein. In some aspects, the backing layer can be interposed between other layers, including the adhesive layer, release liner layer and/or other backing layers. The adhesive layer can be disposed on a backing layer for support. In some aspects, the backing layer is a film. The backing layer can be adhered on the adhesive layer by glue or adhesive. In some aspects, the adhesive layer can be disposed on backing layer. The backing layer needs to be transparent for the color-change of adhesive layer to be observable.

In some industrial applications, the chemochromic indicator can be required to operate in outdoor environments. In some aspects, the chemochromic indicator may further comprise a UV protection and/or absorbing film. In some aspects, the UV protection film can be comprised of a polyimide film. Polyimide films offer an advantage since they filter UV light, which can lead to the protection of the adhesive layer and the chemochromic copper compounds within. However, there is a drawback to using polyimide based films in that they can be damaged if exposed to an alkaline gas or liquid for long periods of time. In leak detection applications, a degraded or fragile film can indicate a chemical gas/liquid leak. In some aspects, a clear film like polyethylene terephthalate (PET), polypropylene, or a clear fluorine base film can be used. Clear film can be preferable because it makes color change detection easier. Fluorine base film (comprising a fluoro carbon polymer such as fluorinated ethylene propylene copolymer (FEP), ethylene tetrafluoroethylene copolymer (ETFE), or polytetrafluoro ethylene (PTFE), polytetrafluoro ethylene hexafluoro propylene copolymer (PFA) and polyethylene have resistance against alkaline. These films have UV resistance. However, since UV can go through film, the film doesn't protect theunderlying adhesive layer. In the case of silicone adhesive, the silicone adhesive itself has UV resistance naturally. If other types of adhesives are used, it is preferable to add UV absorber and/or hindered amine light stabilizers (HALS).

Release Liner

In some aspects, the chemochromic indicator can comprise at least one release liner layer. In some aspects, the chemochromic indicator can comprise one release liner layer. In some aspects, the chemochromic indicator can comprise plural release liner layers. In some aspects, the at least one, one or plural release liner layers can be disposed on the first side or second (opposite) side of the adhesive layer with the copper chemochromic compound therein. In some aspects, the release liner layer can be interposed between other layers, including the adhesive layer, other release liner layers and/or backing layers. In some aspects, the adhesive can be coated on a release liner that is made from paper or polyethylene terephthalate (PET), polyethylene (PE), and/or polypropylene (PP) film. A release liner contains a releasing agent on its surface. Typically, releasing agents are made from silicone polymers and resins. For silicone based adhesives, fluoro silicone polymer can be used as the releasing agent.

If the adhesive layer is coated on a liner which contains a releasing agent on both sides, a single adhesive layer can be provided on the release liner to produce a transfer tape. Transfer tape can be applied on substrates via pressure, and then peeled off the release liner leaving the adhesive layer on the substrate. In case the adhesion is too high, transfer tape type may cause problems after it is applied on the expected leak location since dust and other contaminants can stick on it or when people touch, it is sticky. Self-fusing adhesive is not sticky at room temperature and hence it cannot adhere to the substrate even if pressure is added. However, it can stick on its own backside. To apply self-fusing adhesive on a substrate where a leak is expected, the self-fusing adhesive may need to be fully wrapped around the substrate. A self-fusing adhesive layer can be typically coated on a release liner.

In situations where CuSO₄ loading is high, adhesion can be lost. In this case, more than one adhesive layer can be disposed on the indicator adhesive layer. Extra adhesive layer[s] can be coated on the release liner and/or laminated on a pre-made indicator layer coated on backing film.

Cu(CH₃COOH)₂ with Platinum Cure Dimethyl Silicone Adhesive

Example 1 shows test results of Cu(CH₃COO)₂ (copper (II) acetate) when it was mixed with platinum cure dimethyl silicone adhesive. As chemochromic pigments, Cu(CH₃COO)₂ had some difficulty to be formulated in an adhesive solution and when exposed to ammonia it provided a Δb difference of 6.65. Also, color fading after 2 hrs provided a Δb_{difference} of 0.5, which was a relatively fast fading process. However, still it is feasible to be used as the chemochromic compound to detect leak of ammonia gas or liquid.

CuNO₃ with BPO Cure Methyl Phenyl Silicone Adhesive

Example 2 shows test result of using CuNO₃ as chemochromic compound. Color-change of CuNO₃ sample when exposed to ammonia was Δb_{difference} of 12.53. CuNO₃ coagulated with TiO₂ which provided opacity in adhesive to make color-change clear. It can be preferable to have high opacity for easier color-change recognition.

CuCl₂ with BPO Cure Methyl Phenyl Silicone Adhesive

Example 3-A shows test result of using CuCl₂ trial in silicone adhesive. As shown in Table 7, CuCl₂ can be used as chemochromic pigment in silicone adhesive if it is added about 5 part per 100 adhesive solid part or more. In case of 0.3 parts, color-change when it was exposed to ammonia was too small (ΔL_{difference}=2.23).

Anhydrous CuCl₂ and hydrous CuCl₂ are different in color which are respectively brown and light blue. Because of this difference, color of cured adhesive containing CuCl₂, right after it is taken out from the oven (dried situation) and after it is exposed to moisture are different. However, either color does not interfere with color-change by exposing to ammonia.

CuCl₂ with Acrylic Adhesive

As shown in Example 3-B, CuCl₂ can also be formulated in acrylic adhesive. In this case, adhesive tends to change-color by CuCl₂ when formulated. The level of color-change is totally different from the level of color-change due to ammonia exposure and hence, CuCl₂ can be used as a chemochromic leak indicator pigment.

CuCl₂ with Urethane Adhesive

CuCl₂ can also be formulated in urethane adhesive (Example 3-C). In this case, the color change is yellow-white to blue-green.

CuCl₂ Color Retention Time with BPO Cure Methyl Phenyl Silicone Adhesive

Degree of initial color-change and its retention time is influenced by loading amount of CuCl₂ and thickness of the adhesive layer. According to result of Table 11 in Example 3-D, equal or higher than 5 parts per 100 dry adhesive solid parts of CuCl₂ and adhesive layer thickness of equal or higher than 40 mm are recommended to maintain color-change for over 24 hrs.

CuCl₂ UV Resistance with BPO Cure Methyl Phenyl Silicone Adhesive Using CuCl₂ as chemochromic pigment provides advantage for UV resistance. Example 3-E, Table 12 shows results of UV exposure test. After 400 hrs of UV exposure by xenon lamp which is equivalent to about 10 months of outdoor exposure, the indicator's capability to detect ammonia leak with color-change was retained. In comparison the indicator formulated with pH dye bromo cresol green did not exhibit color-change after 400 hrs of UV exposure (Experiment 3-F, Table 14). The adhesive layer of the pH dye indicator sample was bubbled which is an indication of adhesive decomposition.

Based on these test results with silicone, acrylic, and polyurethane adhesives, it is safe to assume that natural rubber and synthetic rubber base adhesives can also be formulated with CuCl₂.

CuCl₂ is considered a corrosive compound and as a result it may require careful handling like wearing safety gloves when product is handled.

CuSO₄

Example 4 shows test result of using CuSO₄ as chemochromic pigment trial. Unlike Cu(CH₃COO)₂, CuCl₂ and CuNO₃, copper (II) sulfate is not considered a corrosive compound and that is an advantage for handling materials in the process and assuring product's safety as formulated product. Color-change retention time of CuSO₄ is better than Cu(CH₃COO)₂. Hence, CuSO₄ is preferable as chemochromic pigments to be used for ammonia leak indicator. In case of CuSO₄, higher amount need to be formulated compared to CuCl₂.

CuSO₄.5H₂O with BPO Cure Methyl Phenyl Silicone Adhesive

Copper(II) sulfate pentahydrate (CuSO_{4.5}H₂O, 99.99% Sigma Aldrich) is difficult to dissolve in solvent (Example 4-A). However, it can still be dispersed in alcohol with sonication and added into solvent base adhesive. As an alternative approach, it is feasible to make small particles by grinding in solvent using ball mill, etc. If the particles are fine enough and dispersed in solvent, it can be formulated in solvent base adhesive system.

CuSO₄.5H₂O was formulated in BPO cure methyl phenyl silicone adhesive. This sample showed obvious color-change from white to blue to purple when it was exposed to ammonia. (Example 4-A-1) Anhydrous CuSO₄ is preferable to be used since it is easier for the particles to be broken into smaller sizes. When it is formulated, the adhesive color becomes slightly blueish.

Anhydrous CuSO₄ is commercially available and during handling, if it is exposed to air for an extended period of time, it can become hydrated. In order to avoid and minimize rehydration during handling, after weighing, enough solvent was added to the powder to achieve full submersion. If methanol or ethanol is used, amount needs to be limited since those solvents make gelling when those are added in solvent base adhesive. IPA is more tolerable by solvent base adhesive. MEK does not, in general, cause gelling.

To make hydrous or anhydrous CuSO₄ powder small enough as chemochromic pigment that can be dispersed in organic polymer or adhesive, those can be sonicated or ground in solvent that avoid exposing to moisture in air. Typically grinding is done as it is in air or even if solvent is used, it tends to be dried up. In case of sonication, CuSO₄ and solvent can be kept in closed vials or bottles. It can avoid anhydrous CuSO₄ contact to moisture in air. If fine anhydrous CuSO₄ powder gets moisture, particle size tends to be larger and color becomes blueish. So, using sonication with solvent is better than grinding Chemochromic pigment powder size as average is preferably about 10 mm or smaller more; preferably about 5 mm or smaller to get uniform spread in organic polymer layer or adhesive layer.

Anhydrous CuSO₄ with BPO Methyl Phenyl Silicone Adhesive

Table 17 shows various adhesive formulations made based on commercial anhydrous copper sulfate (Sigma Aldrich) chromophore in BPO methyl phenyl silicone adhesive. Loading amount of anhydrous copper was varied from 5 to 25 parts per 100 of silicone adhesive solid part. Also thickness of dry adhesive was varied from 30-50 mm. When these samples were exposed to ammonia gas (Method 2) all of adhesives' colors were obviously changed. Table 18 shows ΔL of color-change when samples are exposed to ammonia.

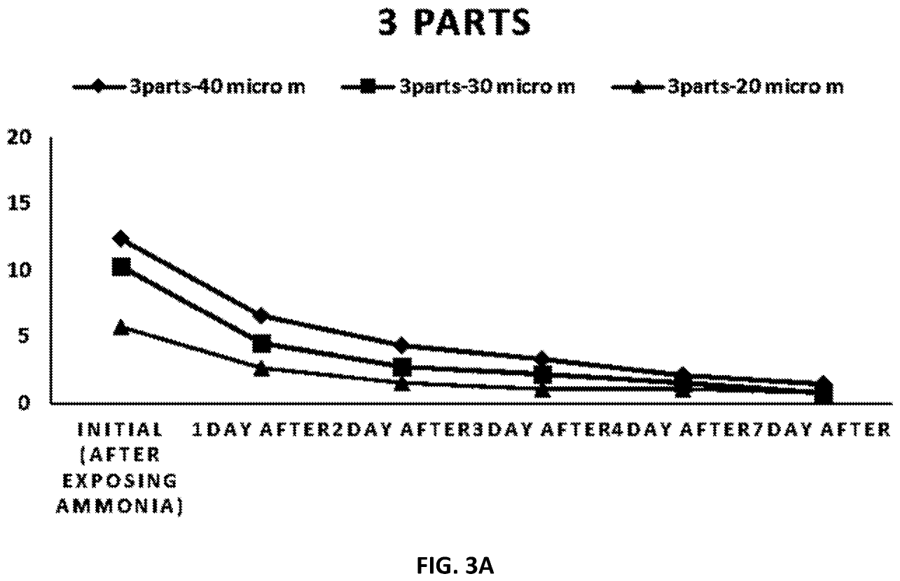

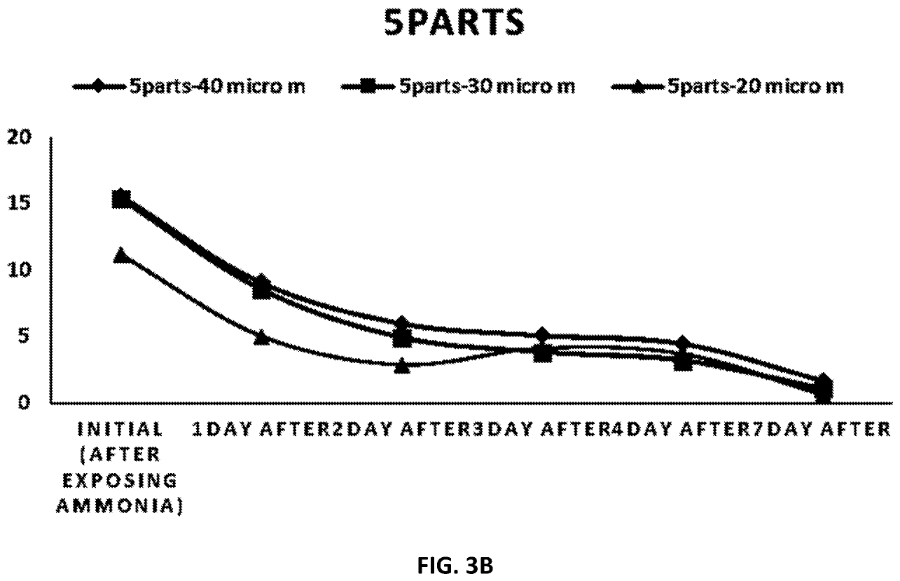

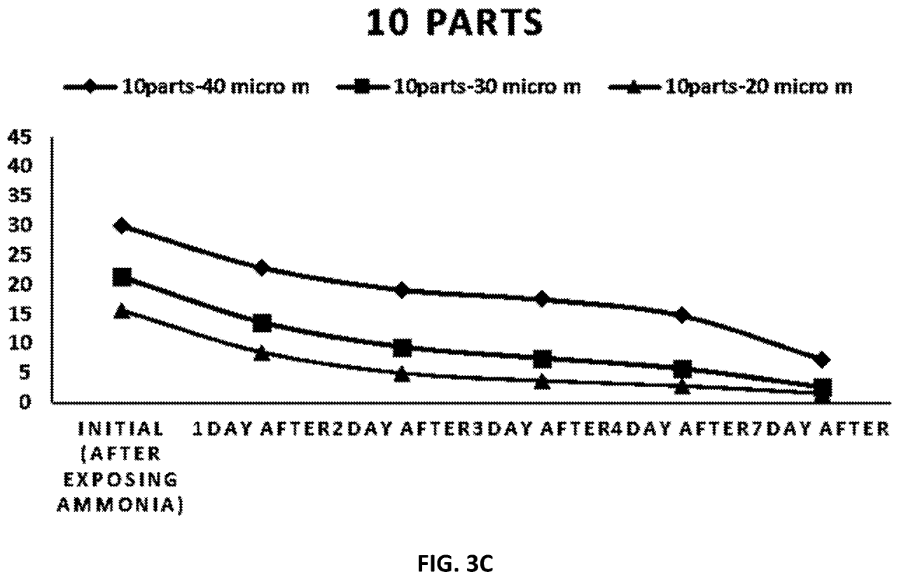

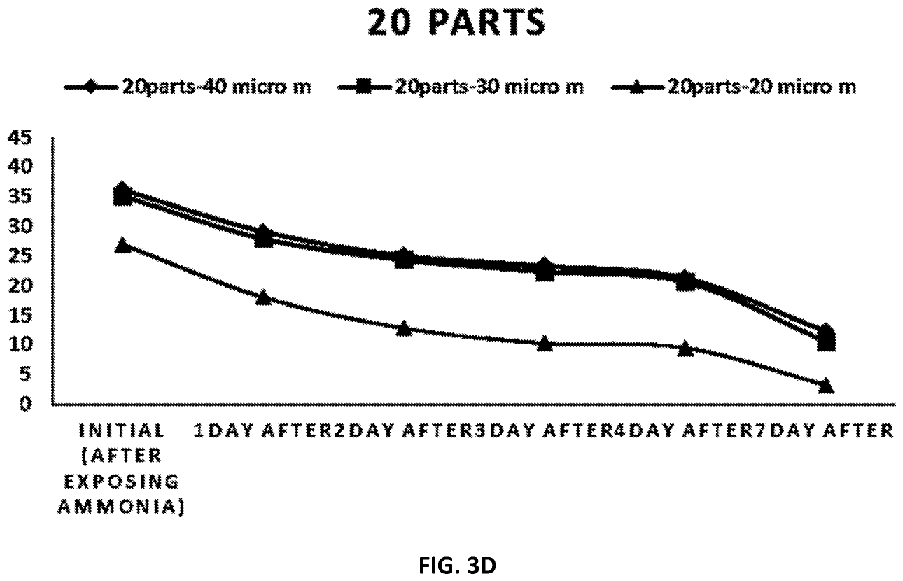

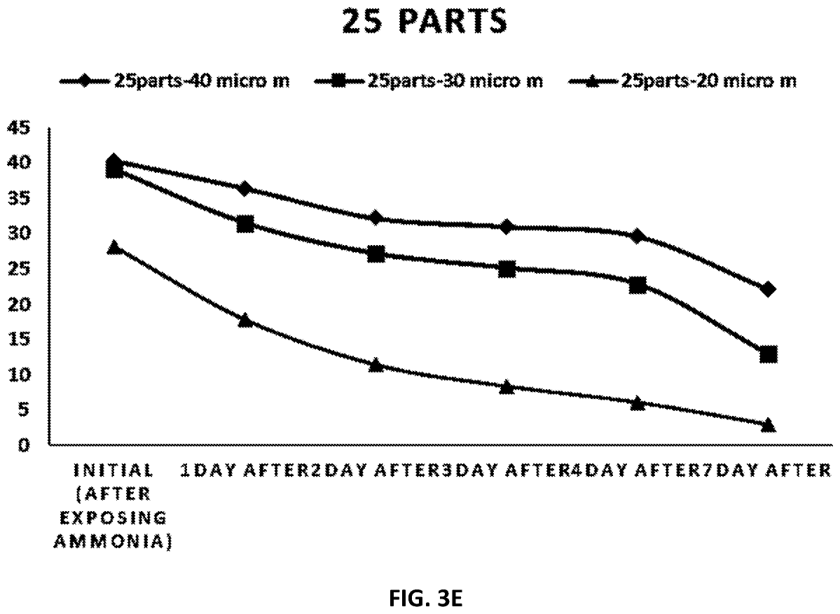

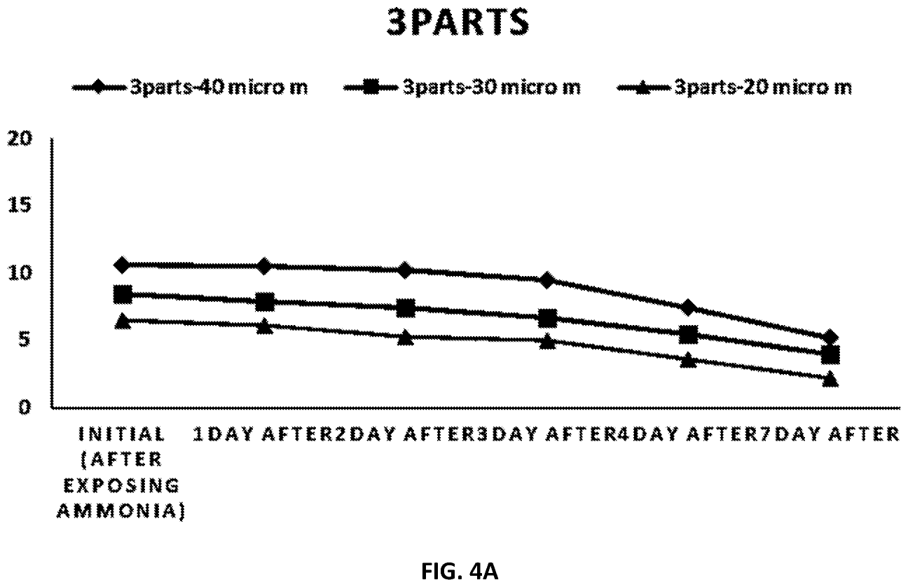

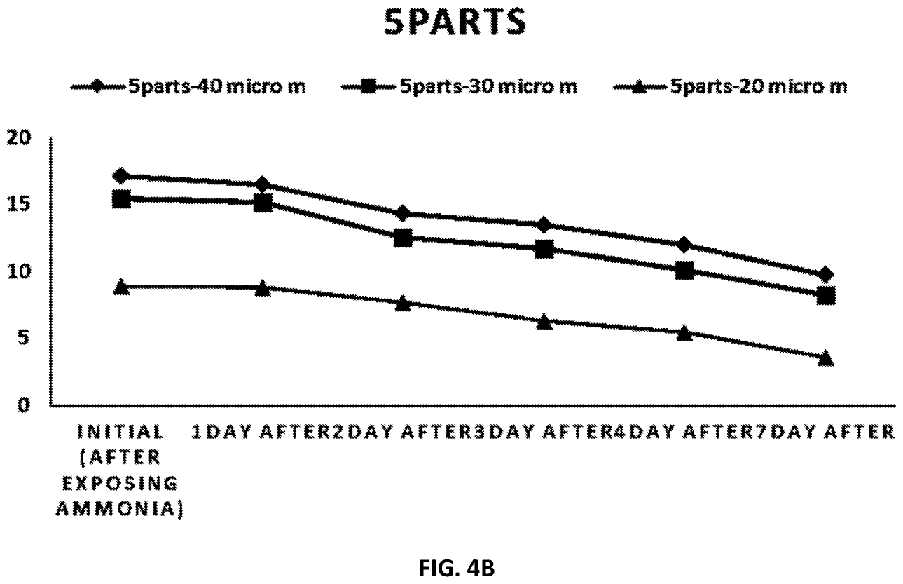

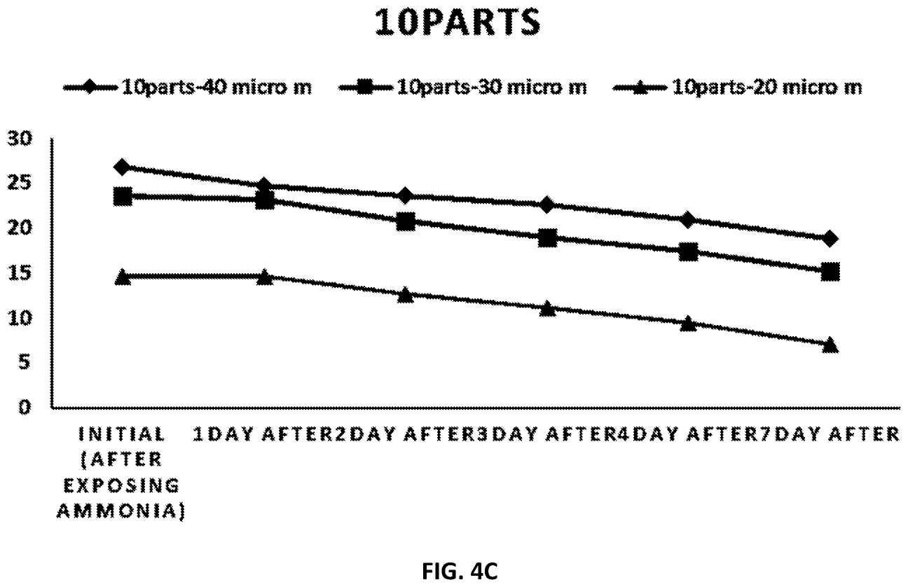

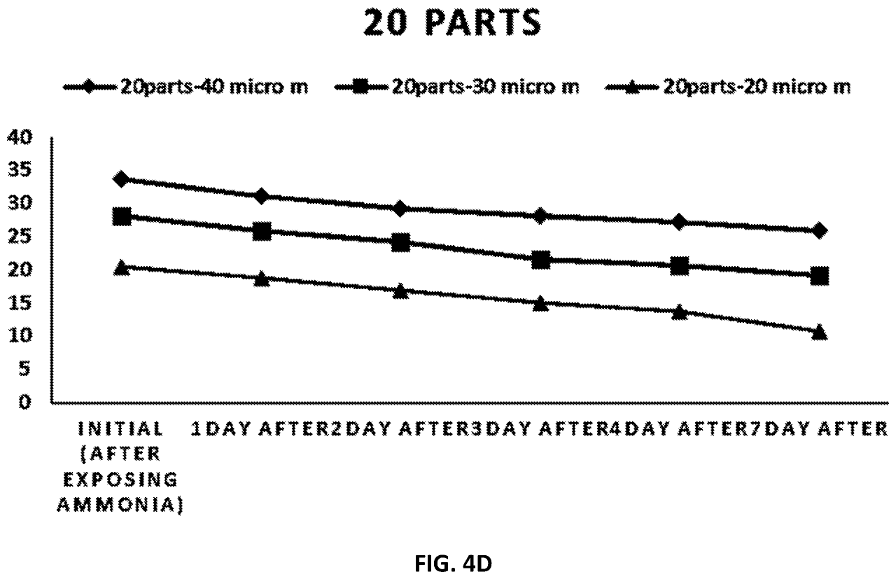

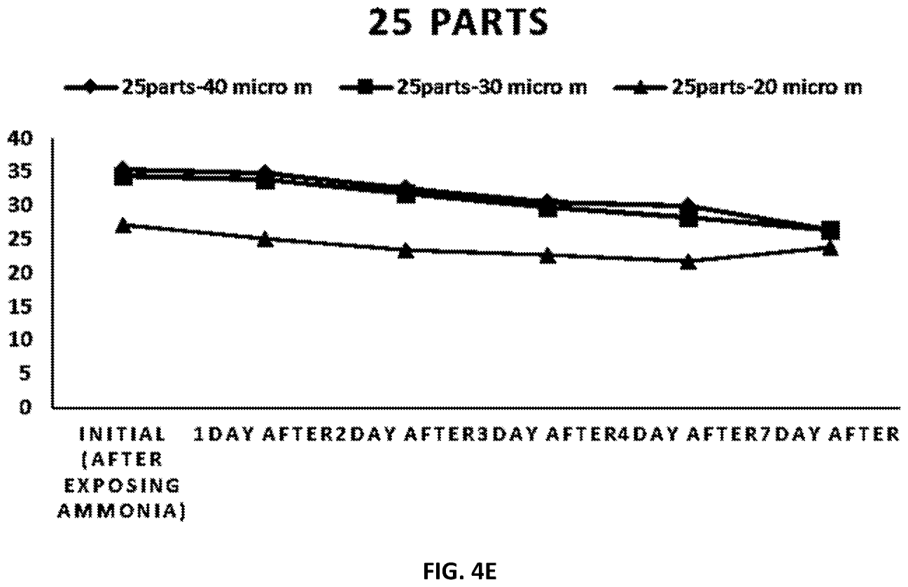

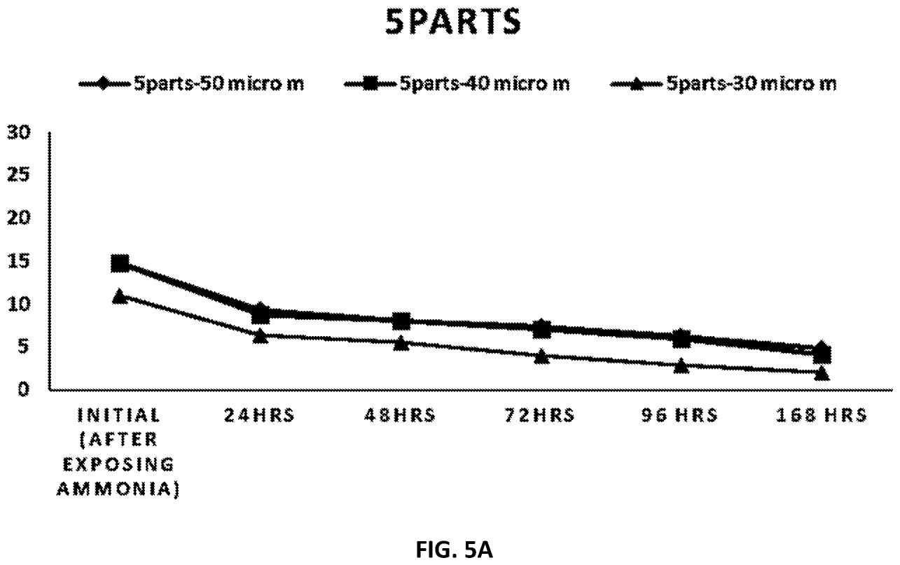

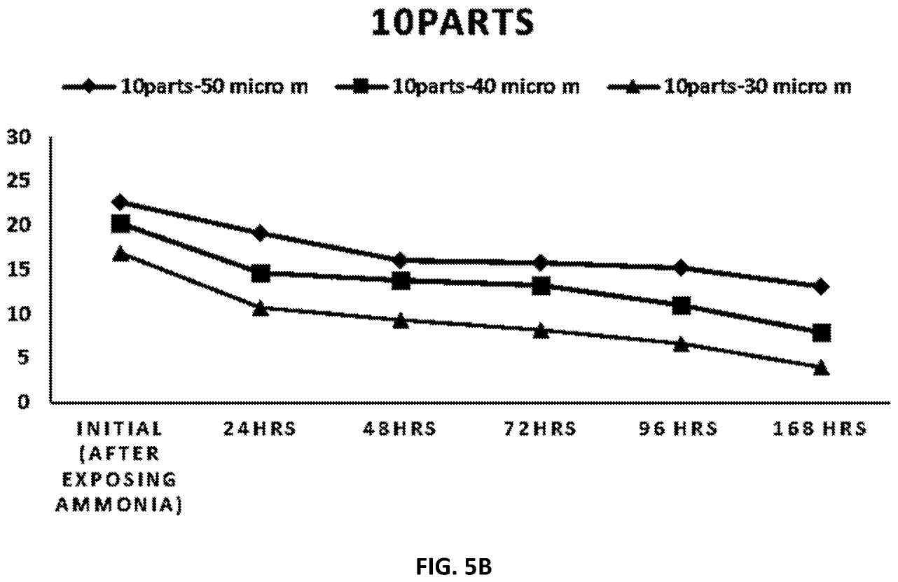

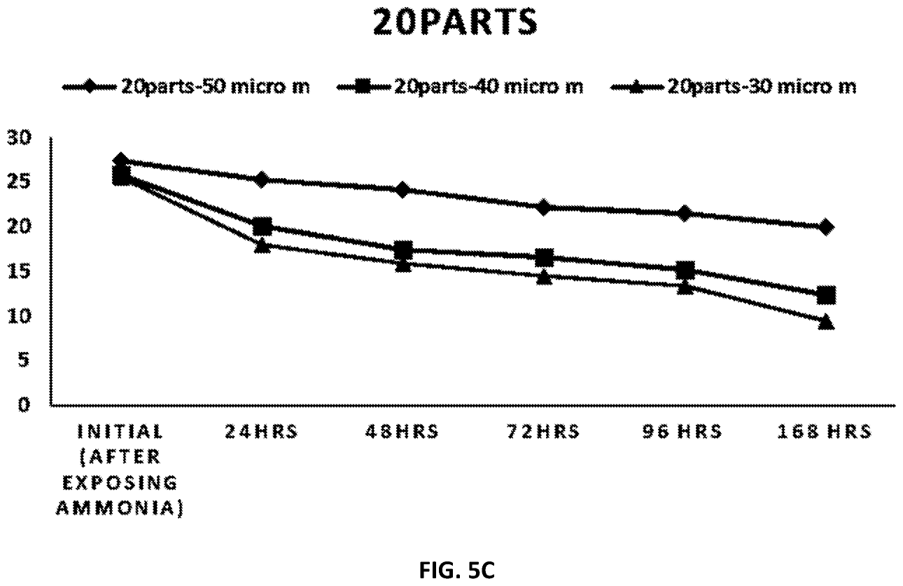

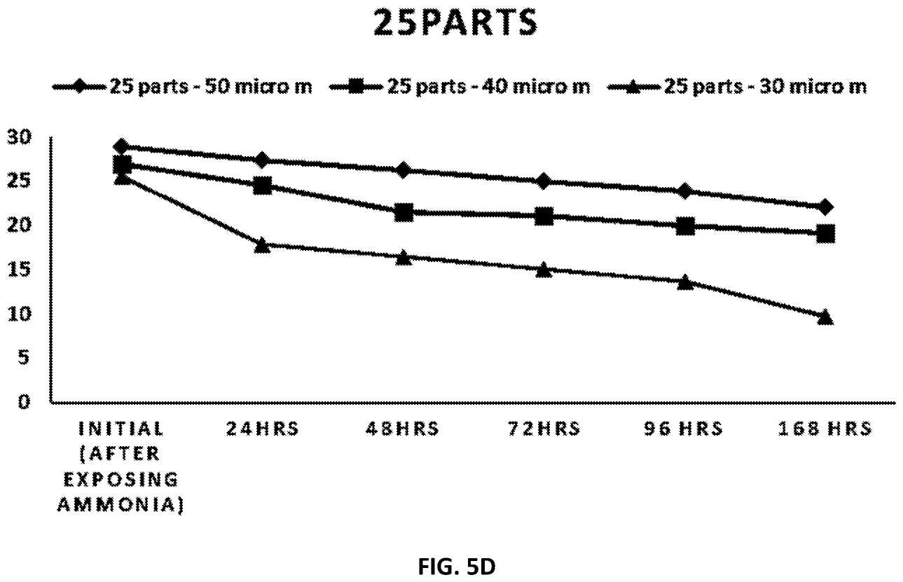

Table 19 and FIGS. 3(a-d) shows ΔL_{difference} of samples from Table 17. These results show that the ΔL_{difference} (level of color-change by ammonia exposure) is influenced by anhydrous CuSO₄ amount and thickness of adhesive layer. Higher loading of anhydrous CuSO₄ and thicker adhesive layer give larger ΔL_{difference} (obvious color-change). Also, it shows that the color fades time by time albeit its fading speed is much slower than pH dyes that color-change tends to fade away right after ammonia gas is removed.

Scheme 1 shows the color-change reaction between anhydrous copper sulfate (white) and ammonia to yield tetramminecopper sulfate monohydrate (purple, deep blue). For visual detection purposes, a ΔL_{difference} or Δb_{difference} of about 5 after about 24 hrs has been targeted (5 is required for the naked eye color-change detection). The ΔL_{difference} increases as the amount of CuSO₄ and adhesive thickness are increased.

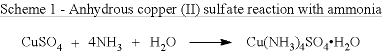

Anhydrous CuSO₄ with Platinum Cure Dimethyl Silicone Adhesive

Anhydrous CuSO₄ was added in to Shin-Etsu KR3700 Pt-cure dimethyl silicone adhesive with various loading amount. Table 20 shows formulations. Amount of anhydrous CuSO₄ was varied from 3 to 25 parts per 100 dry adhesive solid part. The samples were prepared by varying thickness from 20 to 40 mm. In order to make fine powder to get good dispersion in adhesive, anhydrous CuSO₄ was sonicated in IPA and then poured in adhesive solution. Adhesive mixtures were coated on 1 mil PET film. Then, dried and cured in 130° C. oven for 3 min. These specimens were exposed to ammonia gas (Method 2) to see color-change and its retention time. The color-change results are presented in Table 21 which shows Δb, and Table 22 along with FIG. 1(a-e) that show Δb difference of before and after exposure. Color-change and its retention time is influenced by anhydrous CuSO₄ loading amount and adhesive layer thickness. Higher loading and thicker layer provides more obvious color-change and longer retention time. The fading speed of Pt-cure dimethyl silicone adhesive specimens are faster than BPO cure phenyl methyl silicone adhesive specimens.

Anhydrous CuSO₄ with Acrylic Adhesive

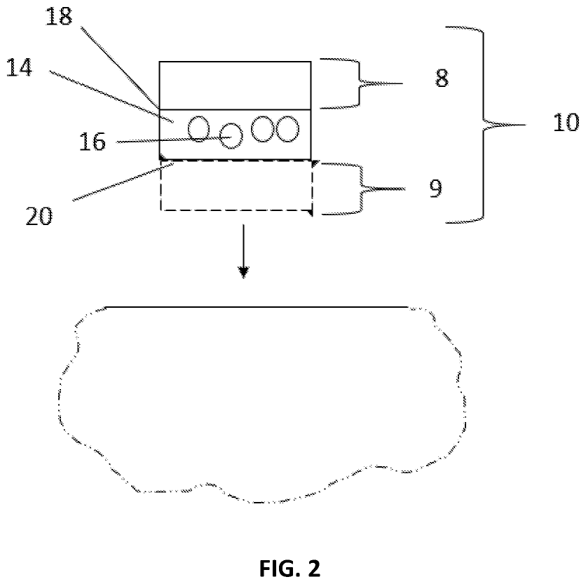

Anhydrous CuSO₄ was added in Toyoink EXK18-052 acrylic adhesive. BXX4805TX (metal chelate) was used as crosslinker. Table 23 shows formulation. Amount of anhydrous CuSO₄ was varied from 3 to 25 parts per 100 dry adhesive solid part. Thickness was varied from 20 to 40 mm. In order to make fine powder to get good dispersion in adhesive, anhydrous CuSO₄ is sonicated in IPA and then poured in adhesive solution. Adhesive mixtures were coated on 1 mil PET film and then, dried and cured in 120° C. oven for 3 min. These specimens were exposed to ammonia gas (Method 2) to see color-change and its retention time. Table 24 shows Δb and Table 25 along with FIG. 2(a-e) show Δb_{difference} that show color difference from before exposure. Color-change and its retention time is influenced by anhydrous CuSO₄ loading amount and adhesive layer thickness. However, fading speed of color is slower than silicone adhesive. Initial color of adhesive layer before exposing ammonia gas is not greenish like when CuCl₂ is added.

Anhydrous Amount and Thickness to Maintain Color Change for Over 24 Hrs, Preferably 48 Hrs

ΔL_{difference} or Δb_{difference} needs to be maintained about 5 preferably about 10 for at least 24 hrs. When CuSO₄ is used as chemochromic pigment, color fading occurs. However, the fading process is not as quick as pH dyes.

Table 22 and FIG. 1(a-e) show color fading vs time in case of Pt-cure dimethyl siloxane silicone adhesive. Thickness of adhesive layer and CuSO₄ were varied. High loading of CuSO₄ and thicker adhesive layer provides more color-change when adhesive layer is exposed to ammonia. If initial has more color-change, fading takes more time. Adding high amount of CuSO₄ lowers adhesion that explained in latter part. If thickness of adhesive layer is too high, it may be bubbling in drying process or adhesive residue may occur when it is peeled off from pipe etc. when it is replaced or peeled off due to color change. So, higher degree of color change needs to be realized by combination of CuSO₄ loading amount and thickness of adhesive layer.

To assure maintaining color-change at 24 hrs, better to evaluate result at 48 hrs. If CuSO₄ loading is equal or higher than 5 parts per 100 dry adhesive part and thickness is equal or higher than 30 mm, color-change (Δb_{difference}) can be maintained as about 5 at 48 hrs. Test result showed 4.91 as 5 parts per 100 dry adhesive part and thickness 30 mm. This case, definitely, Δb_{difference} at 24 hrs is higher than 5. Test result showed 8.51 as 5 parts per 100 dry adhesive part and thickness 30 mm. If CuSO₄ loading is equal or higher than 10 parts per 100 dry adhesive part and thickness is equal or higher than 30 mm, Δb at 48 hrs is 9.42. In this case, Δb at 24 hrs is definitely higher than 10. Test result of CuSO₄ loading is 10 parts per 100 dry adhesive part and thickness is 30 mm, Ab at 24 hrs is 13.57.

To assure maintaining color-change at 48 hrs, better to evaluate result at 72 hrs. If CuSO₄ loading is equal or higher than 10 parts per 100 dry adhesive part and thickness is equal or higher than 30 mm, color-change (Δb_{difference}) can be maintained as higher than 5 at 72 hrs. Test result showed 7.51 as 10 parts per 100 dry adhesive part and thickness 30 mm. This case, definitely, Δb_{difference} at 48 hers is higher than 5. If CuSO₄ loading is equal or higher than 10 parts per 100 dry adhesive part and thickness is equal or higher than 40 mm, Δb at 72 hrs is 17.43. This case, Δb at 48 hrs is definitely higher than 10.

Table 25 and FIG. 2(a-e) show color fading of acrylic adhesive case. In case of acrylic adhesive, color fading speed is slower than silicone adhesive. When CuSO₄ loading is 5 parts per 100 dry adhesive part and thickness is 30 mm, color-change (Δb_{difference}) is 12.53 at 48 hrs. This is surely higher than 5 or 10 at 24 hrs.

In case of acrylic adhesive, color fading speed is slower than silicone adhesive. To assure maintaining color change at 48 hrs, better to evaluate result at 72 hrs. In case CuSO₄ loading is 10 parts per 100 dry adhesive part and thickness is 30 mm, color-change (Δb_{difference}) is 18.98 at 72 hrs. This is surely higher than 5 or 10 at 48 hrs.

Table 19 and FIG. 3(a-d) show color fading of BPO cure methyl phenyl silicone adhesive case. In case of BPO cure phenyl methyl Silone adhesive, color fading speed is almost same as Pt cure dimethyl silicone adhesive. In case CuSO₄ loading is 5 parts per 100 dry adhesive part and thickness is 30 mm, color-change (ΔL_{difference}) is 5.48 at 48 hrs. This is surely higher than 5 at 24 hrs. In case CuSO₄ loading is 10 parts per 100 dry adhesive part and thickness is 30 mm, color-change (ΔL_{difference}) is 9.36 at 48 hrs. This is surely higher than 10 at 24 hrs.

To assure maintaining color change at 48 hrs, better to evaluate result at 72 hrs. In case CuSO₄ loading is 10 parts per 100 dry adhesive part and thickness is 30 mm, color-change (ΔL_{difference}) is 8.20 at 72 hrs. This is surely higher than 5 at 48 hrs. In case CuSO₄ loading is 10 parts per 100 dry adhesive part and thickness is 40 mm, color-change (ΔL_{difference}) is 13.21 at 72 hrs. This is surely higher than 10 at 48 hrs.

RTV Silicone

Anhydrous CuSO₄ is added in moisture curable silicone rubber (RTV, Example 4-B-6. This silicone layer can be considered as leak indicator. This layer doesn't have any tackiness after it is cured by moisture. When the indicator layer is exposed to ammonia gas, it shows obvious color-change. When exposed to ammonia (Method 2), a ΔL_{difference} of 27.3 was measured between the before and after color-change. The color-change is from pale blue to dark purple for the adhesive layer.

In general silicone polymers have three types of curing system: addition cure by platinum catalyst, radical reaction by peroxide, and condensation reaction. All three types can be utilized to form the indicator layer.

Anhydrous Ammonia

Ammonia gas generated from 30% ammonia contains moisture. Example 5-B-5 shows test result of exposing to 7.5% anhydrous ammonia in balance air. Indicator layer (adhesive layer) shows obvious color-change and hence, the indicator is functional even when is exposed to anhydrous ammonia. The ΔL_{difference} for samples with adhesive thickness of 40 mm and 50 mm was measured as 19.36 and 21.2, respectively. These results show that both anhydrous ammonia and ammonium hydroxide can provide good color-change and hence be able to be detected.

Water Immersion

Example 4-B also shows the color-change before and after samples were immersed in water for 12 days. It was observed that the color-change decreased as the thickness decreased. Some loss of CuSO₄ from the indicators, due to leaching out into the water, was also observed. CuSO₄ has high solubility in water but the hydrophobic nature of silicone adhesive was shown to keep the water away from CuSO₄, therefore minimizing its loss in water. Furthermore, the color of the adhesive while it was submerged remained white (i.e. the color blue for hydrated copper sulfate was not observed).

Liquid Ammonia

Example 4-B-8 shows that when indicator with anhydrous CuSO₄ was soaked in 30% aqueous ammonia, color of this indicator layer (adhesive layer) was changed from white to purple/blue. Therefore, this chemochromic indicator can work for ammonia gas and/or liquid ammonia leak detection.

UV Resistance of Anhydrous CuSO₄

Example 4-B-7 shows the effect of UV on specimens made from anhydrous CuSO₄ in Pt-cure dimethyl silicone adhesive. 20 parts per 100 dry adhesive part of anhydrous CuSO₄ was formulated in Pt-cure dimethyl silicone adhesive. This adhesive as coated on 1 mil PET and Polyimide. Coated films are exposed to UV from film side for 600 hrs by UV lamp that is about 1-year outdoor exposure. Even after samples are exposed to UV, ammonia detection ability is well maintained (Table 30).

Comparison

As comparison, NiCl₂ & NiSO₄ were tested as described in comparison. Ni is well known to react with ammonia. NiCl₂ and NiSO₄ were formulated in phenyl methyl silicone adhesive SilGrip™ 518. However, those specimens didn't show any color-change when exposed to ammonia.

Method for Indicating Ammonia

In some aspects, a method for indicating the presence of an ammonia compound is described, wherein the method can comprise contacting ammonia with a chemochromic indicator comprising an adhesive layer comprising a chemochromic compound described above. In some aspects upon contact, a color change as described can indicate the presence of ammonia gas. In some aspects, the method can comprise determining a difference between a post-exposure colorimetric state of the chemochromic indicator and a pre-exposure colorimetric state of the chemochromic indicator. In some aspects, the copper compound can be copper sulfate. In some aspects, the adhesive layer can comprise a contrasting color compound.

The method can include obtaining a pre-exposure chemochromic state of the chemochromic indicator. In some aspects the method can comprise obtaining a post-exposure chemochromic state of the chemochromic indicator. In some aspects, the method can comprise determining a difference in a chemochromic state of the chemochromic indicator following the contacting step and determining the presence or absence of a difference in the chemochromic state relative to a pre-exposure chemochromic state or that of a control. Measuring or determining the chemochromic state of a material is optionally performed by one or more of many techniques known in the art. Illustratively, chemochromic state is determined by visual inspection. Optionally, a chemochromic state is determined using a spectrometer, optionally a Fourier transform infrared (FTIR) spectrometer, to determine chemochromic state of the sorbent at one or multiple wavelengths or ranges of wavelengths. Illustrative examples of such spectroscopic techniques can be found in Peterson, et al., Industrial & Engineering Chemistry Research, 2013; 53:701-707. Other illustrative methods for measuring or determining the presence or absence of a difference in chemochromic state include UV/V is spectrometry, photoluminescence, luminescence, and fluorescence.

In some aspects, the post-exposure chemochromic state is used to determine or measure chemochromic indicator contact with or exposure to ammonic, and optionally to quantify the amount of ammonia thereof that has contacted the sorbent by comparison to a pre-exposure chemochromic state or control. A pre-exposure chemochromic state can be measured prior to a chemochromic indicator contacting an ammonia compound using the same techniques as are used for measuring a post-exposure chemochromic state. An altered chemochromic state indicates that the chemochromic indicator has contacted an ammonia compound. A chemochromic state can be optionally altered in transmission at one or more wavelengths, reflection at one or more wavelengths, absorption at one or more wavelengths, or fluoresces or luminescence at one or more wavelengths. In some aspects, the post-exposure chemochromic state can be compared to a control. A control can be a chemochromic state of a pre-exposure chemochromic indicator similar or identical chemochromic indicator contacted with the ammonia compound. A difference between a post-exposure chemochromic state and a pre-exposure chemochromic state or control allows for the sensing or quantifying contact of a chemochromic indicator with an ammonia compound or other environmental condition.

A chemochromic state is a spectral condition of a sorbent. A chemochromic state is observable, and optionally quantifiable, visually or using instrumentation. A chemochromic state is observed as a color, a spectral pattern, an intensity of spectral emission(s), or combinations thereof.

In some aspects the color altering layer may have the following parameters: L*—Lightness Value, a*—position on red-green axis, and b*—position on yellow-blue axis.

$$Δ {E}^{*} = {\{ {( L - {L}^{′} )}^{2} + {( a - {a}^{′} )}^{2} + {( b - {b}^{′} )}^{2} \}}^{1 / 2}$$

The equation above can be used in a standard measurement with which to compare different samples' color changes. The greater the ΔE* value, the greater the color contrast. The chemochromic films can be analyzed both before and after exposure to ammonia, allowing quantification of the intensity of color change.

In some aspects, the color altering layer may have the following parameters:

$$Δ {L}_{difference} = \vert Δ {L}_{after} - Δ {L}_{before} \vert or$$

$$Δ {b}_{difference} = \vert Δ {b}_{after} - Δ {b}_{before} \vert$$

Method for Making Ammonia Indicator

In some aspects, a method for manufacturing the aforedesecribed chemochromic indicator is described, the method can comprise dispersing hydrous or anhydrous CuSO₄ in an organic solvent to create a dispersion. In some aspects, a method for manufacturing a chemochromic indicator is described, the method can comprise sonicating the dispersion so as to create a copper slurry. In some aspects a method for manufacturing a chemochromic indicator is described, the method can comprise adding the copper slurry to a polymer so as to create a mixture. In some aspects a method for manufacturing a chemochromic indicator is described, the method can comprise coating the mixture onto a backing layer or release liner for drying and curing. In some aspects a method for manufacturing a chemochromic indicator is described, the backing layer can comprise polyethylene terephthalate (PET). In some aspects a method for manufacturing a chemochromic indicator is described, the release liner can be a fluorocarbon release liner. One suitable example includes mixing a compound of about 20 wt % Silicon polymer, 0.06 wt % Pt, 0.6 wt % TiO₂, 5 wt % MEK; 1.8 wt % CuSO₄; 6.98 wt % IPA and 2.4 wt % toluene. In one suitable example, the mixing compound has been sonicated. In one suitable example, the substituents therein can be uniformly dispersed throughout the mixing compound.

In some aspects, the method can comprise adding a release liner layer to the free side of the chemochromic indicator and/or adhesive. In some aspects, the release liner can be formed from a polyester-based resin. In some aspects, the release linerlayer can be a fluorocarbon release liner.

### Example 1

Using Cu(CH₃COO)₂ as Chemochromic Pigments

Silicone adhesive was used to test if copper (II) acetate (Cu(CH₃COO)₂, 98%, Alfa Aesar) can be used as a chemochromic pigments since it has UV resistance and wider temperature usage range.

In general, solvent base adhesive contains non-polar solvents like xylene and toluene. For the formulation, it is highly critical to know about the solubility of each component. Table 2 shows attempts that were made to dissolve various percentages of Cu(CH₃COO)₂ in different solvents.

TABLE 2
Solubility of Cu(CH₃COO)₂

| Solvent | |
|---|---|
| (% Cu(CH₃COO)₂) | Result |
| MEK (5%) | Blue solution, Majority settled |
| IPA (5%) | Blue solution, Majority settled |
| MeOH (5%) | Better solubility, couldn't dissolve all |
| MeOH (2%) | Better solubility, couldn't dissolve all |
| MeOH (1%) | With sonication all were dissolved (based |
| | on naked eye. Next day fine powder settlement |
| | was observed) |
| EtOH (1%) with | All were dissolved (next day, settlement was not |
| sonication | observed) |
| EtOH (2%) with | Not all were dissolved, settlement was present |
| sonication | |

In general, the solubility of Cu(CH₃COO))₂ in non-polar solvent like toluene that can be formulated in an adhesive does not appear to be good. As shown in Table 2, Cu(CH₃COO)₂ could be dissolved in ethanol as 1% solution. It was assumed that adding 3 to 20 parts of Cu(CH₃COO)₂ per 100 of adhesive solid part was required to get sufficient color-change. In the case of 1% solution and in order to introduce sufficient amount of copper to the test sample, very high amount of ethanol was added into the adhesive solution. This caused gelling of the silicone adhesive, which does not provide proper coating properties. Table 3 shows the formulation and gas exposure test results for Cu(CH₃COO)₂ in Pt-cure dimethyl silicone adhesive.

TABLE 3
Formulation and gas exposure test result for
Cu(CH₃COO)₂ in Pt-cure dimethyl silicone adhesive

| | |
|---|---|
| Curing temperature (° C.) | 130 |
| Curing time (min.) | 3 |
| Backing film | 92 gauge (0.023 mm) Clear PET |
| Adhesive thickness when Dry (mm) | 45 |
| ShinEtsu KR3700(g) (60% solids) | 20 |
| CAT-PL-50T (g) | 0.06 |
| Toluene (dilute CAT-PT-50T) (g) | 0.54 |
| Toluene | 2 |
| TiO₂ (g) | 0.6 |
| MEK (g) | 2 |
| MEK Rinse | 0.5 × 2 |
| Cu(CH₃COO)₂ (g) | 1.8 |
| MEK (g) | 16 |
| MEK Rinse (g) | 1 × 2 |
| Ammonia exposure result | Obvious color change from |
| (adhesive) | green to brown |
| Δb before exposing to ammonia | 6.18 |
| Δb after exposing to ammonia | 12.83 |
| Δb difference (initial) | 6.65 |
| Δb 2 hrs after exposing to ammonia | 5.68 |
| Δb difference (2 hrs after) | −0.5 |

Formulation: 1.8 g of Cu(CH₃COO)₂ was added to 16 g of MEK in a 30 ml glass vial and was sonicated to disperse all Cu(CH₃COO)₂ by ultrasonic cleaner Branson 200 (Emerson, Mo. USA) for 5 min. two times to break down particles and to disperse in solvent. 10 g of solution part was taken and left for one day. Then, fine green powder was precipitated. This fine powder was small enough in particle size to be added into the adhesive formulation. In order to minimize the amount of added MEK in the adhesive solution, the liquid part of the solution was taken out as much as possible. Then, toluene (30 g) was added. The slurry was left for 2 days. Again, the liquid part of the solution was taken out as much as possible (about 10 g solution remained). Although the exact amount of Cu(CH₃COO)₂ that remained for the formulation was unknown in this case, it is possible to weigh the amount of Cu(CH₃COO)₂ in the removed solvent after it is dried.

Titanium dioxide (TiO₂, rutile, Sigma-Aldrich) was added into the Cu(CH₃COO)₂ slurry and sonicated using an ultrasonic cleaner (Branson 200) for 5 min. CAT-PT-50T (0.06 g) and toluene (2.54 g) were added to the KR3700 adhesive (20 g) and mixed. Then, Cu(CH₃COO)₂ and TiO₂ slurry were added to the adhesive and mixed.

It is preferable for the adhesive to contain TiO₂ in order to increase opacity so that when the tape is exposed to ammonia, the color-change is more easily recognizable. To avoid coagulation of TiO₂ in the adhesive, it is preferable to first disperse TiO₂ in the solvent and then mix with the adhesive. In case of hydrophilic TiO₂, using MEK is most preferable if compatibility with adhesive is considered.

Using Method 1, this adhesive was coated on 92-gauge PET (Melinex-S, DuPont Teijin Films, Virginia USA) to create a coated sample. Coagulation of Cu(CH₃COO)₂ was observed on the adhesive layer.

A specimen (35 mm×35 mm) was cut from the coated sample. This specimen was exposed to ammonia gas test Method 2.

### Example 2

Using CuNO₃ as Chemochromic Pigments

For a formulation, it is highly critical to know about the solubility of each component. Table 4 shows attempts that were made to dissolve various percentages of copper (II) nitrate (CuNO₃, 99%, Acros Organics) in different solvents.

TABLE 4
Solubility of CuNO₃

| Solvent | |
|---|---|
| (% CuNO₃) | Result |
| MEK (50%) | Not soluble |
| MEK (33%) | Not Soluble |
| MEK (25%) | Soluble |
| IPA (25%) | Soluble |

CuNO₃ can be dissolved in IPA or MEK in certain solid % (25%) at room temperature. In the case of mixing with a silicone adhesive, it is preferable to use MEK for better compatibility. MEK was used for this formulation. Table 5 shows the formulation and gas exposure test results for CuNO₃ in BPO-cure methyl phenyl silicone adhesive.

TABLE 5
Formulations and Gas Exposure Test Results for
CuNO₃ in BPO-cure methyl phenyl silicone adhesive

| | |
|---|---|
| Curing temperature (° C.) | 177 |
| Curing time (min.) | 3 |
| Backing film | 1 mil Polyimide |
| Adhesive thickness when dry (mm) | 50 |
| SilGrip ™ 518 (55.5%) (g) | 4.688 |
| BPO (g) | 0.063 |
| Toluene (BPO solving) (g) | 1.000 |
| Toluene rinse (g) | 0.500 |
| TiO₂ (g) | 0.150 |
| MEK Rinse (g) | 0.5 × 2 |
| Extra Toluene (g) | 1.000 |
| CuNO₃ (g) | 1.04 |
| MEK (dissolve CuNO₃) (g) | 3.12 |
| Ammonia exposure result (adhesive) | Obvious color change from |
| | green to Purple |
| ΔL before exposing to NH₃ | 32.94 |
| ΔL after exposing to NH₃ | 45.47 |
| ΔL_{difference} | 12.53 |

Formulation: BPO was dissolved in toluene in a small container and poured into the SilGrip™ 518 adhesive. The small container was rinsed with toluene, poured into the adhesive again and mixed to create an adhesive mixture. CuNO₃ was dissolved in MEK as 25% at R.T. 4.16 g of CuNO₃ solution was weighed in a 30 ml glass vial. TiO₂ was weighed and added into this vial. In order to get good dispersion, this TiO₂ and CuNO₃ solution was sonicated for 5 min. After sonication was done, this slurry was poured into the adhesive mixture. The vial was rinsed with 0.5 g MEK two times and the rinse was mixed into the adhesive mixture. However, some part of the adhesive mixture gelled. 1 g toluene was added to the adhesive mixture to make it smooth.

This adhesive mixture was coated on 1 mil polyimide film so as to achieve a dried adhesive thickness of 50 mm using Method 1. The sample was air dried for 3 min., and then cured at 177° C. for 3 min., resulting in a coated sample from which several specimens were cut. The adhesive layer had many tiny spots that suggests that the TiO₂ and CuNO₃ are coagulated. Some interaction between the TiO₂ and CuNO₃ was noticed. Since the TiO₂ was coagulated, the coated sample had lost some opacity. As a result, color change recognition was not as good as that of a highly opaque adhesive layer. However, color change was still noticeable. When one specimen from the coated sample was exposed to ammonia (Method 2), the initial ΔL before it was exposed to ammonia was 32.94, and the ΔL after it was exposed to ammonia was 45.47. The ΔL_{difference} was calculated as 12.53. It is preferable for the ΔL_{difference} to be equal to about 5 upon detection so that the color-change can be more easily recognized by the naked eye. More preferably ΔL_{difference} to be equal to about 10. Therefore ΔL_{difference} of 12.53 is enough. However, due to less opacity, it is not easy to recognize color-change, especially on darker color background (on darker color painted pipes, etc.).

### Example 3

Using CuCl₂ as Chemochromic Pigments

Copper (II) chloride, CuCl₂, can chemochromically react with ammonia or H₂S. In order to add CuCl₂ to an adhesive uniformly, it was considered to dissolve CuCl₂ in a solvent, and then mix with the adhesive. Table 6 shows attempts that were made to dissolve various percentages of CuCl₂ in different solvents.

TABLE 6
Solubility of CuCl₂

| Solvent | |
|---|---|
| (% CuCl₂) | Result |
| IPA (5%) | Not soluble at R.T. At 70° C., solution could be |
| | made. |
| Ethanol (10%) | Solution can be made at R.T. |
| Methanol (20%) | Solution can be made at R.T. |
| Xylene (5%) | Even at 80° C., solution could not be made. |
| Toluene (5%) | Even at 80° C., solution could not be made. |
| MEK (0.5%) | Even at 80° C., solution could not be made. |

3-A) Formulated CuCl₂ in silicone adhesive: Based on the solubility study results, dissolving CuCl₂ (99%, Sigma Aldrich) in ethanol or methanol was preferable. However, when CuCl₂ solution was made with ethanol or methanol and added to a silicone adhesive (SilGrip™ 518 methyl phenyl silicone BPO cure type), the adhesive mix gelled. No gelling was observed when only methanol or ethanol were added in the adhesive and mixed (up to certain ratio). The presence of CuCl₂ and BPO (benzoyl peroxide) enhanced gelling. Although the solubility of CuCl₂ was lower, it was preferable to dissolve it in IPA instead o fusing ethanol or methanol. IPA can be mixed with silicone adhesive up to certain amount. When IPA was used to dissolve CuCl₂, even in the presence of CuCl₂ or BPO, gelling up of the adhesive was not observed. Table 7 presents the adhesive mixing formulation and test results for coated samples containing CuCl₂.

TABLE 7
CuCl₂ Adhesive mixing formulation and test results

| | | |
|---|---|---|
| Curing temperature (° C.) | 177 | 177 |
| Curing time (min.) | 3 | 3 |
| Backing film | 1 mil | 1 mil |
| | Polyimide | Polyimide |
| Adhesive thickness when dry | 40 | 40 |
| (mm) | | |
| SilGrip ™ 518 (55.5%) (g) | 4.7 | 4.7 |
| BPO (g) | 0.063 | 0.063 |
| Toluene (BPO dissolving) (g) | 0.63 | 0.63 |
| Toluene (g) | 1.0 | 1.0 |
| TiO₂ (g) | 0.15 | 0.15 |
| MEK disperse (g) | 1.0 | 1.0 |
| MEK Rinse (g) | 0.5 × 2 | 0.5 × 2 |
| CuCl₂ (g) | 0.13 | 0.008 |
| IPA (g) | 2.47 | 2.47 |
| Ammonia exposure result | Obvious color change | Slightly darker |
| (adhesive) | from white to green | Not obvious |
| ΔL before exposing to ammonia | 27.43 | 29.09 |
| ΔL after exposing to ammonia | 43.69 | 31.32 |
| ΔL_{difference} | 16.26 | 2.23 |

Formulation: SilGrip™ 518 (4.7 g) adhesive was weighed. BPO (0.063 g) was weighed and it was dissolved in toluene (0.63 g) before it was poured into the SilGrip™ 518 adhesive. The BPO container was rinsed with 0.5 g toluene two times. Each time, the rinse was poured into the adhesive and mixed.

CuCl₂ (0.13 g or 0.008 g) and IPA (2.47 g) are added in a 30 mL glass vial and then heated up in a 70° C. water bath. The vial was swirled slowly from time to time until the CuCl₂ was dissolved completely. Once all of the CuCl₂ was dissolved, the glass vial was taken out from the water bath and cooled down. In the case of 5% in IPA, even after the vial was cooled down, the CuCl₂ stayed in solution.

0.15 g of TiO₂ was weighed in a 30 mL glass vial and MEK (1 g) was added in. This glass vial that has TiO₂ and IPA was sonicated for 5 min. using an ultrasonic cleaner (Branson 200). After the sonication was done, this slurry was poured into a SilGrip™ 518 adhesive that has BPO. The vial was rinsed with 0.5 g MEK two times. Each time, the MEK was poured into the SilGrip™ 518 adhesive.

The SilGrip™ 518 adhesive that has BPO, TiO₂ and CuCl₂ in the solution was mixed well to provide an adhesive mixture. The adhesive mixture was coated on a 1 mil polyimide film as thickness of dried adhesive, 40 mm using Method 1. When this sample was exposed to ammonia gas as test Method 2, color of adhesive was changed from white to blue. This blue color was changed to green over time.

Loading amount of CuCl₂ are 5 parts per 100 dry adhesive solid part and 0.3 parts per 100 dry adhesive solid parts. For ammonia leak detection, higher amount of CuCl₂ loading is better.

3-B) Formulated CuCl₂ in acrylic adhesive: Table 8 shows the formulation and gas exposure test results for acrylic-based CuCl₂ containing Indicators.

TABLE 8
CuCl₂ Formulation in Acrylic Adhesive

CuCl₂ ratio (parts per 100 of
silicone adhesive solid part)

| | 5 | 5 | 5 |
|---|---|---|---|
| Cure temperature (° C.) | 120 | 120 | 120 |
| Cure time (min.) | 3 | 3 | 3 |
| Backing film | 1 mil | 1 mil | 1 mil |
| | polyimide | polyimide | polyimide |
| NXT-533 (solid 48%) (g) | 20 | — | — |
| EXK18-052 (solid 50%) | — | — | 10.4 |
| (g) | | | |
| NXT 800 (solid 34%) (g) | — | 20 | — |
| TiO₂ (g) | 0.48 | 0.34 | 0.26 |
| MEK disperse (g) | 3 | 3 | 2 |
| MEK Rinse (g) | 1 | 1 | 1 |
| CuCl₂ (g) as IPA 5% | 0.48 | 0.34 | 0.26 |
| solution (g of CuCl₂) | | | |
| IPA (g) | 9.12 | 6.46 | 4.94 |
| Adhesive thickness when | 45 mm | 40 mm | 40 mm |
| dry | | | |
| Color of adhesive right | Some are | Some are | Clear |
| after sample was cured in | greenish | greenish | |
| oven | | | |
| Ammonia gas exposure | Obvious | Obvious | Obvious |
| | Green | Green | Green |

Formulation: CuCl₂ and IPA were put in a 30 ml glass vial as 5% solution. This vial was heated up in a 70° C. water bath so as to dissolve the CuCl₂ completely. After it was dissolved, the solution was cooled down to R.T. TiO₂ and MEK were weighed and put into the 30 ml glass vial. This glass vial was sonicated for 5 min. This TiO₂ solution was poured into a weighed acrylic adhesive. The vial was rinsed with MEK, which was then added to the acrylic adhesive. The CuCl₂ solution was added into the acrylic adhesive. Then, all were mixed together well.

This mixed adhesive was coated on several 1 mil polyimide films (Method 1). After the coated films were air dried for about 3 min., they were placed in an oven at 120° C. for 3 min. to dry and cure. Both NXT-533 (Toyo Ink, TX USA) and NXT800 (Toyo Ink) comprise acrylic polymer, crosslinker (metal chelate), and inhibitor solvent. When the inhibitor solvent is evaporated, the acrylic polymer can be cured. EXK18-052 (Toyo Ink) comprises only the acrylic polymer that is used for NXT-533 and it does not contain crosslinker and inhibitor solvent.

When each adhesive sample was taken out from the oven, the adhesive's color for some of the coated samples was slightly green. When a sample was left in ambient condition, gradually, the adhesive color changed into green even without the presence of ammonia gas. When CuCl₂ was added into just the acrylic polymer EXK18-052, the color of the sample did not appear greenish. However, when this tape sample was dipped in water for 24 hrs, the adhesive color changed to green. This green color may avoid leak detection by color-change.

In this specific case, this greenish color was caused by the chemical interaction between the acrylic polymer and CuCl₂, and not by curing agent.

3-C) Formulated CuCl₂ in urethane adhesive: Table 9 shows the formulation and gas of urethane-based indicator with CuCl₂.

TABLE 9
CuCl₂ and Urethane Adhesive Formulation

| | CuCl₂ ratio (parts per 100 of | |
|---|---|---|
| | silicone adhesive solid part) | |
| | 5 | |
| Curing temp (° C.) | 100 | |
| Curing time (min.) | 3 | |
| Backing film | 2 mil PET | |
| Av. adhesive thickness as dry | 45 | |
| (mm) | | |
| SPUR 1015 (g) | 10 | g |
| Tytan S6 (g) | 0.1 | g |

| | |
|---|---|
| CuCl₂ (g) | 0.5 |
| IPA (g) | 19.5 |
| TiO₂ (g) | 0.25 |
| MEK disperse (g) | 2.0 |
| MEK rinse (g) | 1.0 |
| Ammonia exposure result | Obvious color change from |
| (adhesive) | yellow white to blue-green |

Formulation: 0.5 g CuCl₂ and 19.5 g IPA was weighed and put into a 30 ml glass vial as 2.5% solution. This vial was heated up in a 70° C. water bath to dissolve the CuCl₂ completely. After it was dissolved, the solution was cooled down to room temperature.

Ethylacetoacetate titanate (Tytan S6, Borica Co. Ltd, Taiwan) was weighed and put into a silylated polyurethane (SPUR 1015, Momentive, NY USA). TiO₂ (0.25 g) and MEK (2.0 g) were weighed and put into a glass vial. This vial was sonicated for 5 min. and poured into the SPUR 1015 silylated polyurethane. The vial was rinsed with 1 g MEK which was again poured into the SPUR1015 silylated polyurethane. The CuCl₂ solution was added into the SPUR1015 silylated polyurethane. Then, all were mixed well. This adhesive mixture was coated on 2 mil (0.0508 mm) PET film with a thickness of 45 m when it was dried and cured. Curing temperature was 100° C. for 3 min.

The ammonia gas exposure test was carried out (Method 2) and it showed an obvious color change.

3-D) Color retention time: Existing chemochromic gas indicators for ammonia do not retain their color change. If gas flow is stopped, the color reverts back. This is not helpful to determine the exact location of the leak since gas tends to be stopped after it is noticed by a gas pressure drop or detected by an area sensor. Therefore, it is preferable if a detection tape's color change remains for 2 to 6 hrs, preferably for over 24 hrs.

TABLE 10
Formulations for color retention test
of CuCl₂ in BPO-cure silicone adhesive

| | CuCl₂ ratio (parts per 100 of | | |
|---|---|---|---|
| | silicone adhesive solid part) | | |
| | 1 | 3 | 5 |
| Curing temperature (° C.) | 177 | 177 | 177 |
| Curing time (min.) | 3 | 3 | 3 |
| Backing film | 2 mil PET | 2 mil PET | 2 mil EPT |
| SilGrip ™ 518 (55.5%) (g) | 4.69 | 4.69 | 4.69 |
| BPO (g) | 0.063 | 0.063 | 0.063 |
| Toluene (g) | 0.625 | 0.625 | 0.625 |
| TiO₂ (g) | 0.15 | 0.15 | 0.15 |
| MEK dispersion (g) | 0.7 | 0.7 | 0.7 |
| MEK rinse (g) | 2.5 | 2.5 | 2.5 |
| Extra MEK (g) | 1.0 | 1.0 | 1.0 |
| CuCl₂ (g) | 0.026 | 0.078 | 0.130 |
| Ethanol (g) | 0.234 | 0.702 | 1.17 |
| Av. adhesive thickness (mm) | 55 | 50 | 30, 40, 65 |

Formulation: CuCl₂ and ethanol were weighed and added into a 30 ml glass vial as 10% solution. It was mixed slowly until it was dissolved. SilGrip™ 518 adhesive was weighed. BPO was dissolved in toluene. TiO₂ (0.15 g) and MEK (0.7 g) were weighed in a glass vial. CuCl₂ solution was also weighed and added into the same vial. This glass vial was sonicated for 5 min. and then poured into the SilGrip™ 518 adhesive. The vial was rinsed two times and the rinse was added to the adhesive. All were mixed together. This adhesive was coated on 2 mil PET using Method 1 and air dried for about 3 min at R.T. and then dried and cured at 177° C. for 3 min.

The CuCl₂ loading amount was varied as 1, 3, and 5 parts per 100 SilGrip™ 518 adhesive solid part to respectively create formulation samples of Table 10. Also, with regard to adhesive mix with 5 parts CuCl₂, the average (Av.) thickness of the adhesive was varied as to 30 mm, 40 mm, and 65 mm. The samples were exposed to ammonia for 10 min. The ΔL was measured at the initial point, after 2 hrs, 6 hrs, and 24 hrs in order to calculate the ΔL_{difference} (Table 11). When the ΔL was measured, a 1 mil polyimide film was placed on each sample to measure the color change as a black and white difference.

TABLE 11
ΔL Difference for initial and fading rate
by varying CuCl₂ amount and adhesive thickness

| | CuCl₂ ratio (parts per 100 of | | | | |
|---|---|---|---|---|---|
| | silicone adhesive solid part) | | | | |
| | 1 | 3 | 5 | 5 | 5 |
| Av. adhesive thickness | 50 | 50 | 30 | 40 | 65 |
| (mm) | | | | | |
| ΔL_{difference} Initial | 7.81 | 13.62 | 10.75 | 14.67 | 19.93 |
| ΔL_{difference} 2 hrs | 3.45 | 5.85 | 4.69 | 6.97 | 12.36 |
| ΔL_{difference} 6 hrs | 3.18 | 4.43 | 3.83 | 5.66 | 10.22 |
| ΔL_{difference} 24 hrs | 2.64 | 4.67 | 4.54 | 5.99 | 9.93 |

3-E) UV Resistance

TABLE 12
Formulation for UV resistance study
CuCl₂ in BPO-cure silicone adhesive specimen

| | CuCl₂ ratio (parts per 100 of |
|---|---|
| | silicone adhesive solid part) |
| | 5 |
| Curing temperature (° C.) | 177 |
| Curing time (min.) | 3 |
| Backing film | 1 mil |
| | polyimide |
| Av. thickness of adhesive as dry | 45 |
| (mm) | |
| SilGrip ™ 518 (55.5%) (g) | 9.375 |
| BPO (g) | 0.125 |
| Toluene (g) | 1.25 |
| TiO₂ (g) | 0.3 |
| MEK disperse (g) | 3 |
| MEK Rinse (g) | 4 |
| CuCl₂ (g) | 0.26 |
| Ethanol (g) | 2.34 |

Formulation: CuCl₂ and ethanol were weighed and put into a 30 ml glass vial. This vial was heated up in a 70° C. water bath in order to dissolve the CuCl₂ completely. Once it was dissolved, then the solution was cooled down to room temperature.

A SilGrip™ 518 adhesive was weighed. BPO was weighed and dissolved in toluene, then added into the SilGrip™ 518 adhesive. TiO₂ and MEK were measured and put into the 30 ml glass vial. This vial was sonicated for 5 min. and poured into the SilGrip™ 518 adhesive. The vial was rinsed with MEK, which was then poured into the adhesive and mixed. The adhesive was coated on 1 mil polyimide film using Method 1. After the adhesive was air dried for about 3 min., then it was dried and cured in a 177° C. oven for 3 min.

3-F) Comparison with pH Dye BCG

TABLE 13
Formulation for UV resistance study with pH dye BCG

| | |
|---|---|
| Curing temperature (° C.) | 177 |
| Curing time (min.) | 3 |
| Backing film | 1 mil polyimide |
| Av. thickness of adhesive as dry (mm) | 45 |
| SilGrip ™ 518 (55.5%) (g) | 75 |
| BPO (g) | 1 |
| Toluene (g) | 10 |
| TiO₂ (g) | 2.45 |
| MEK disperse (g) | 15 |
| MEK rinse (g) | 10 |
| Bromo cresol green (g) | 0.15 |
| MEK (g) | 2.85 |

Formulation: Bromo cresol green (0.15 g) was dissolved in (2.85 g) MEK. SilGrip™ 518 adhesive (75.0 g) was weighed. BPO (1 g) was weighed and dissolved in 10 g toluene. TiO₂ (2.45 g) and MEK (15 g) were weighed and sonicated for 5 min. The BPO solution, BCG solution, and TiO₂ solution were added into the SilGrip™ 518 adhesive and all were mixed together to achieve an adhesive mixture. This adhesive was coated on a 1 mil polyimide film. After it was air dried for about 3 min., it was dried and cured in a 177° C. oven for 3 min.

The samples were exposed to UV in a sunshine weather-ometer (Super xenon weather meter SX-75, 7.5KW xenon arc lamp, Suga test instrument Co. Japan) for 100 hrs & 400 hrs. UV was irradiated from the polyimide backing film side.

Then, the samples were exposed to ammonia gas (Method 2) and the ΔL_{difference} was measured (Method 3)

TABLE 14
ΔL_{Difference} for UV-exposed specimens
with CuCl₂ and BCG after ammonia exposure

| | CuCl₂ | BCG |
|---|---|---|
| Formulation | (Table 12) | (Table 13) |
| Initial ΔL_{difference} | 14.93 | 15.59 |
| ΔL_{difference} after | 14.69 | 13.76 |
| 100 hrs | | |
| ΔL_{difference} after | 16.14 | 2.2 |
| 400 hrs | | |

Table 14 shows that the specimen with BCG was decomposed by UV before 400 hrs. As a result, the ammonia exposure test (Method 2) didn't show significant color-change (ΔL_{difference}=2.2, Method 3). On the contrary, the specimen with CuCl₂ still showed good color-change for ammonia exposure after 400 hrs UV exposure (ΔL_{difference}=16.14). Although the majority of UV was filtered out by polyimide, the BCG sample still couldn't withstand the UV exposure.

### Example 4

Copper (II) Sulfate as Chemochromic Pigments

4-A) CuSO₄.5H₂O

In order the examine the efficiency of copper (II) sulfate pentahydrate (CUSO₄.5H₂O, 99.99% Sigma Aldrich) in the chemochromic detection of ammonia gas, it is preferable to add it to an adhesive in a uniform way. Therefore, the solubility in different solvents had to be studied (Table 15).

TABLE 15
CUSO₄•5H₂O solubility study

| Solvent | |
|---|---|
| (% CuSO₄•5H₂O) | Result |
| Methanol (0%) | Not soluble at R.T. |
| Ethanol (20%) | Not soluble at R.T. The precipitation was mostly |
| | white with some blue crystals. |
| Ethanol (2%) | Sonicated, not soluble. White precipitation and |
| | cloudy. |
| Isopropanol (20%) | Not soluble and no white precipitation. |
| Toluene (20%) | Not soluble and no white precipitation. |
| Water (40%) | Soluble at R.T. |

% in ( ) is weight % of CuSO₄•5H₂O in each solvent that was confirmed as soluble.

The solubility of CuSO₄.5H₂O in organic solvents is very low but it has good solubility in water. These formulations presented a gelling challenge due to extra water of hydration on the copper sulfate particles. The water of hydration on CuSO₄.5H₂O causes the polarity of the adhesive mixture to be increased and hence causes gelation. When CuSO₄.5H₂O is not soluble in MeOH at R.T. but when mixed the hydroxyl of methanol behave the same as water of hydration and cause gelation. Sonication of CuSO₄.5H₂O in ethanol (EtOH) caused the blue particles to change to white fine powder. But even after washing this powder with IPA, the high surface polarity of the particles caused gelling. This was still due to hydroxyl interaction with adhesive which increases the polarity.

4-A-1) CuSO₄.5H₂O formulated in BPO cure silicone adhesive: Table 16 shows indicators based on CuSO₄.5H₂O chromophore, BPO cure SilGrip™ PSA518 and 1 mil PI backing material. In order to reduce the particle sizes of crystalline CuSO₄.5H₂O, longer durations of sonication were used. In some examples the CuSO₄.5H₂O was crushed to a powder in a mortar and pestle. Presence of MEK in general caused the coagulation of CuSO₄.5H₂O particles after being added to the adhesive and hence resulted in some imperfect drawdown samples. All indicators were coated by using Method 1.

To reduce surface polarity of the chromophore particles, CuSO₄.5H₂O was baked in the oven at 150° C. for 60 min. Baking of CuSO₄.5H₂O provided a fine white powder (Scheme 2 below). It is believed that in this process, greater than 90% of water hydration was removed. The dehydrated copper sulfate, after it was sonicated and dispersed, provided a stable adhesive mix.

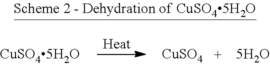

TABLE 16
Baked CuSO₄•5H₂O, SilGrip ™ PSA518 and 1 mil PI/Kapton100

| Mass Quantities (g) | | | | | | | Color change by |
|---|---|---|---|---|---|---|---|
| Baked | | | | | | PSA (55.5% | ammonia exposure |
| CuSO₄•5H₂O | TiO₂ | MEK | IPA | BPO | Toluene | solid) | (Method 2) |
| 0.5 | 0.15 | — | 2 | 0.063 | 1.5 | 4.7 | Obvious color change |
| (20 parts) | | | | | | | from white to blue, |
| | | | | | | | purple |

Formulation:

CuSO₄.5H₂O (0.5 g) was baked at 150° C. for 60 min. The blue color changed to white. To the baked CuSO₄.5H₂O, IPA (2 g) was added and sonicated for 10 min. TiO₂ (0.15 g) was added to the CuSO₄ slurry and sonicated for 5 min. This slurry was added to SilGrip™ 518 adhesive (4.7 g) and BPO (0.063 g)/toluene (1 g) and mixed.

4-B) Anhydrous Copper (II) Sulfate

4-B-1) Anhydrous CuSO₄ Formulation with BPO Cure Methyl Phenyl Silicone Adhesive

TABLE 17
Anhydrous CuSO₄, BPO-cured methyl phenyl silicone, and
1 mil PI/Kapton100 (% against PSA solid part) for

| | | | | | | | Average |
|---|---|---|---|---|---|---|---|
| CuSO₄(g), | Mass Quantities (g) | | | | | PSA | Adhesive |
| (parts) | TiO₂ | IPA | BPO (%) | Toluene | PSA | Material | Thickness (μm) |
| 3.9 (25) | 0.9 | 11 | 0.372(2.4) | 4 | 28.11 | Mom. | 30 |
| | | | | | | PSA518 | |
| 3.9 (25) | 0.9 | 11 | 0.372(2.4) | 4 | 28.11 | Mom. | 40 |
| | | | | | | PSA518 | |
| 3.9 (25) | 0.9 | 11 | 0.372(2.4) | 4 | 28.11 | Mom. | 30 |
| | | | | | | PSA518 | |
| 3.9 (25) | 0.9 | 11 | 0.372(2.4) | 4 | 28.11 | Mom. | 40 |
| | | | | | | PSA518 | |
| 3.9 (25) | 0.9 | 11 | 0.372(2.4) | 4 | 28.11 | Mom. | 50 |
| | | | | | | PSA518 | |
| 3.12 (20) | 0.9 | 11 | 0.372(2.4) | 4 | 28.11 | Mom. | 30 |
| | | | | | | PSA518 | |
| 3.12 (20) | 0.9 | 11 | 0.372(2.4) | 4 | 28.11 | Mom. | 40 |
| | | | | | | PSA518 | |
| 3.12 (20) | 0.9 | 11 | 0.372(2.4) | 4 | 28.11 | Mom. | 50 |
| | | | | | | PSA518 | |
| 1.58 (10) | 0.9 | 11 | 0.372(2.4) | 4 | 28.11 | Mom. | 30 |
| | | | | | | PSA518 | |
| 1.58 (10) | 0.9 | 11 | 0.372(2.4) | 4 | 28.11 | Mom. | 40 |
| | | | | | | PSA518 | |
| 1.58 (10) | 0.9 | 11 | 0.372(2.4) | 4 | 28.11 | Mom. | 50 |
| | | | | | | PSA518 | |
| 0.78 (5) | 0.9 | 11 | 0.372(2.4) | 4 | 28.11 | Mom. | 30 |
| | | | | | | PSA518 | |
| 0.78 (5) | 0.9 | 11 | 0.372(2.4) | 4 | 28.11 | Mom. | 40 |
| | | | | | | PSA518 | |
| 0.78 (5) | 0.9 | 11 | 0.372(2.4) | 4 | 28.11 | Mom. | 50 |
| | | | | | | PSA518 | |

Formulation Steps:

Anhydrous CuSO₄ (for the amount, refer to Table 17) and TiO₂ (0.9 g) in IPA (11 g) was sonicated for 5 min. BPO (0.372 g) was dissolved in toluene (4 g) and added to the adhesive (28.11 g, referred to as “Mom. PSA518” in Table 17 and mixed. Then, CuSO₄/TiO₂ slurry was added to the adhesive and mixed.

Loading amount and thickness vs. color retention time: Table 18 and Table 19 show the initial color-change ΔL and the ΔL_{difference} for 25 parts CuSO₄, 20 parts CuSO₄, 10 parts CuSO₄, and 5 parts CuSO₄ when exposed to ammonia (Method 2) for different adhesive thicknesses where their color was fading over time.

TABLE 18
BPO cure methyl phenyl silicone adhesive: CuSO₄ loading amount,
adhesive thickness vs ΔL color-change time by time

| | | | delta b from backing side 1 mil PET) | | | | | | |
|---|---|---|---|---|---|---|---|---|---|
| CuSO4 dry | | | Original | Initial | | | | | |
| parts per 100 | Dry thickness | delta b | (before | (After | | | | | |
| adhesive | of adhesive | measured | exposing to | exposing | 24 hrs | 48 hrs | 72 hrs | 96 hrs | 168 hrs |
| solid part | (micro m) | surface | ammonia) | ammonia) | after | after | after | after | after |
| 5 | 50 | film side | 24.58 | 39.36 | 33.93 | 32.61 | 31.87 | 30.77 | 29.39 |
| 5 | 40 | film side | 24.51 | 39.32 | 33.25 | 32.52 | 31.6 | 30.52 | 28.59 |
| 5 | 30 | film side | 24.98 | 35.96 | 31.31 | 30.46 | 29.02 | 27.89 | 26.96 |
| 10 | 50 | film side | 24.86 | 47.42 | 43.98 | 40.87 | 40.56 | 40.09 | 37.94 |
| 10 | 40 | film side | 24.83 | 45.07 | 39.38 | 38.62 | 38.04 | 35.82 | 32.78 |
| 10 | 30 | film side | 25.85 | 42.75 | 36.62 | 35.21 | 34.05 | 32.51 | 29.83 |
| 20 | 50 | film side | 25.39 | 52.67 | 50.69 | 49.54 | 47.57 | 46.88 | 45.37 |
| 20 | 40 | film side | 25.03 | 50.82 | 45.17 | 42.38 | 41.61 | 40.21 | 37.42 |
| 20 | 30 | film side | 24.65 | 50.23 | 42.56 | 40.54 | 39.12 | 38.07 | 34.07 |
| 25 | 50 | film side | 24.32 | 53.24 | 51.63 | 50.51 | 49.22 | 48.14 | 46.33 |
| 25 | 40 | film side | 25.44 | 52.31 | 49.97 | 46.92 | 46.51 | 45.33 | 44.55 |
| 25 | 30 | film side | 25.39 | 50.91 | 43.29 | 41.76 | 40.45 | 38.97 | 35.09 |

TABLE 19
BPO cure methyl phenyl silicone adhesive: CuSO₄ loading amount,
adhesive thickness vs ΔL_{difference} change time by time

| | | | delta b difference | | | | | | |
|---|---|---|---|---|---|---|---|---|---|
| CuSO4 dry | | | Original | Initial | | | | | |
| parts per 100 | Dry thickness | delta b | (before | (After | | | | | |
| adhesive | of adhesive | measured | exposing to | exposing | 24 hrs | 48 hrs | 72 hrs | 96 hrs | 168 hrs |
| solid part | (micro m) | surface | ammonia) | ammonia) | after | after | after | after | after |
| 5 | 50 | film side | — | 14.78 | 9.35 | 8.03 | 7.29 | 6.19 | 4.81 |
| 5 | 40 | film side | — | 14.81 | 8.74 | 8.01 | 7.09 | 6.01 | 4.08 |
| 5 | 30 | film side | — | 10.98 | 6.33 | 5.48 | 4.04 | 2.91 | 1.98 |
| 10 | 50 | film side | — | 22.56 | 19.12 | 16.01 | 15.7 | 15.23 | 13.08 |
| 10 | 40 | film side | — | 20.24 | 14.55 | 13.79 | 13.21 | 10.99 | 7.95 |
| 10 | 30 | film side | — | 16.9 | 10.77 | 9.36 | 8.2 | 6.66 | 3.98 |
| 20 | 50 | film side | — | 27.28 | 25.3 | 24.15 | 22.18 | 21.49 | 19.98 |
| 20 | 40 | film side | — | 25.79 | 20.14 | 17.35 | 16.58 | 15.18 | 12.39 |
| 20 | 30 | film side | — | 25.58 | 17.91 | 15.89 | 14.47 | 13.42 | 9.42 |
| 25 | 50 | film side | — | 28.92 | 27.31 | 26.19 | 24.9 | 23.82 | 22.01 |
| 25 | 40 | film side | — | 26.87 | 24.53 | 21.48 | 21.07 | 19.89 | 19.11 |
| 25 | 30 | film side | — | 25.52 | 17.9 | 16.37 | 15.06 | 13.58 | 9.7 |

Water Immersion: The sample with 20 parts per 100 adhesive dry parts of anhydrous CuSO₄ in Table 17 was coated on 1 mil PET as dry adhesive thickness 50 mm. The specimen was dried and cured in 130° C. for 3 min. This specimen was immersed in water for 12 days. Then, after it was taken out from water, it was dried and exposed to ammonia to see if still ammonia detection ability is there. ΔL_{difference} was calculated based on ΔL before and after ammonia exposure. Before water exposure the ΔL_{difference} for the specimen was 27.28 and after 12 days of water immersion, the specimen ΔL_{difference} was 23.59.

4-B-2) Anhydrous CuSO₄ with Platinum Cure Dimethyl Silicone Adhesive

TABLE 20
Pt cure dimethyl silicone adhesive formulation- Varied CuSO₄ loading amount

| | | CuSO₄ dry parts per 100 adhesive solid part | | | | | |
|---|---|---|---|---|---|---|---|
| Material | Solid % | 3 | 5 | 10 | 15 | 20 | 25 |
| KR3700 | 60 | 10 | 10 | 10 | 10 | 10 | 10 |
| CAT-PT-50T | 2.5 | 0.03 | 0.03 | 0.03 | 0.03 | 0.03 | 0.03 |
| Toluene (Cat. Dilution) | 0 | 0.27 | 0.27 | 0.27 | 0.27 | 0.27 | 0.27 |
| Toluene (Cat. Dilution) | 0 | 1 | 1 | 1 | 1 | 1 | 1 |
| anhydrous CuSO₄ | 100 | 0.18 | 0.3 | 0.6 | 0.9 | 1.2 | 1.5 |
| IPA | 0 | 3 | 3 | 3 | 3 | 3 | 3 |
| IPA (Rinse) | 0 | 1 | 1 | 1 | 1 | 1 | 1 |
| TiO₂ | 100 | 0.3 | 0.3 | 0.3 | 0.3 | 0.3 | 0.3 |
| MEK | 0 | 2 | 2 | 2 | 2 | 2 | 2 |
| MEK (Rinse) | 0 | 1 | 1 | 1 | 1 | 1 | 1 |
| Extra Toluene | 0 | 0 | 0 | 0 | 2 | 2 | 2 |

Formulation Steps:

Anhydrous CuSO₄ (for the amount, refer to Table 20) was sonicated in IPA (3 g) for 5 minutes. TiO₂ (0.3 g) in MEK (2 g) was sonicated for 5 min. CAT-PT-50T (0.03 g) and toluene (1.27 g) were added to the KR3700 adhesive (10 g) and mixed. Then, CuSO₄ and TiO₂ slurry were added to the adhesive and mixed. The adhesive mix was coated on a 1 mil PET film.

Loading, Thickness Vs. Color-Change Retention:

Table 21 and Table 22 show the initial color-change Δb and the Δb_{difference} for 25 parts CuSO₄, 20 parts CuSO₄, 10 parts CuSO₄, 5 parts CuSO₄, and 3 parts CuSO₄ in Pt-cure dimethyl silicone adhesive when exposed to ammonia (Method 2) for different adhesive thicknesses where their color was fading over time.

TABLE 21
Pt cure dimethyl silicone adhesive - CuSO₄ loading amount, adhesive thickness vs Δb time by time

| | | | delta b from backing side 1 mil PET) | | | | | | |
|---|---|---|---|---|---|---|---|---|---|
| CuSO4 dry | | | Original | Initial | | | | | |
| parts per 100 | Dry thickness | delta b | (before | (After | | | | | |
| adhesive | of adhesive | measured | exposing to | exposing | 24 hrs | 48 hrs | 72 hrs | 96 hrs | 168 hrs |
| solid part | (micro m) | surface | ammonia) | ammonia) | after | after | after | after | after |
| 3 | 40 | Film side | −1.02 | 11.36 | 5.55 | 3.27 | 2.29 | 1.05 | 0.38 |
| 3 | 30 | Film side | −0.69 | 9.6 | 3.81 | 2.1 | 1.49 | 0.85 | 0.14 |
| 3 | 20 | Film side | −0.75 | 4.99 | 1.9 | 0.79 | 0.29 | 0.36 | 0.06 |
| 5 | 40 | Film side | −1.22 | 14.35 | 7.83 | 4.74 | 3.85 | 3.22 | 0.39 |
| 5 | 30 | Film side | −0.57 | 14.73 | 7.94 | 4.34 | 3.23 | 2.6 | 0.48 |
| 5 | 20 | Film side | −0.53 | 10.57 | 4.49 | 2.33 | 3.59 | 3.15 | 0.09 |
| 10 | 40 | Film side | −1.13 | 28.69 | 21.65 | 17.93 | 16.3 | 13.59 | 6.19 |
| 10 | 30 | Film side | −0.93 | 20.33 | 12.64 | 8.49 | 6.58 | 4.81 | 1.67 |
| 10 | 20 | Film side | −0.66 | 15.03 | 7.87 | 4.33 | 3.02 | 2.13 | 0.89 |
| 20 | 40 | Film side | −0.53 | 35.69 | 28.58 | 24.48 | 22.77 | 20.74 | 11.7 |
| 20 | 30 | Film side | −0.28 | 34.87 | 27.63 | 24.09 | 22.1 | 20.35 | 10.34 |
| 20 | 20 | Film side | −0.12 | 26.86 | 17.97 | 12.77 | 10.24 | 9.47 | 3.22 |
| 25 | 40 | Film side | −0.96 | 39.33 | 35.46 | 31.23 | 30.05 | 28.69 | 21.24 |
| 25 | 30 | Film side | −0.06 | 38.98 | 31.41 | 27.09 | 25.06 | 22.79 | 12.86 |
| 25 | 20 | Film side | −0.33 | 27.89 | 17.56 | 11.13 | 8.08 | 5.82 | 2.69 |

TABLE 22
Pt cure dimethyl silicone adhesive - CuSO₄ loading amount,
adhesive thickness vs Δb difference change time by time

| | | | delta b difference | | | | | | |
|---|---|---|---|---|---|---|---|---|---|
| CuSO4 dry | Dry thickness | | Original | Initial | | | | | |
| parts per 100 | of adhesive | delta b | (before | (After | | | | | |
| adhesive | Target | measured | exposing to | exposing | 24 hrs | 48 hrs | 72 hrs | 96 hrs | 168 hrs |
| solid part | (micro m) | surface | ammonia) | ammonia) | after | after | after | after | after |
| 3 | 40 | Film side | 0 | 12.38 | 6.57 | 4.29 | 3.31 | 2.07 | 1.4 |
| 3 | 30 | Film side | 0 | 10.29 | 4.5 | 2.79 | 2.18 | 1.54 | 0.83 |
| 3 | 20 | Film side | 0 | 5.74 | 2.65 | 1.54 | 1.04 | 1.11 | 0.81 |
| 5 | 40 | Film side | 0 | 15.57 | 9.05 | 5.96 | 5.07 | 4.44 | 1.61 |
| 5 | 30 | Film side | 0 | 15.3 | 8.51 | 4.91 | 3.8 | 3.17 | 1.05 |
| 5 | 20 | Film side | 0 | 11.1 | 5.02 | 2.86 | 4.12 | 3.68 | 0.62 |
| 10 | 40 | Film side | 0 | 29.82 | 22.78 | 19.06 | 17.43 | 14.72 | 7.32 |
| 10 | 30 | Film side | 0 | 21.26 | 13.57 | 9.42 | 7.51 | 5.74 | 2.6 |
| 10 | 20 | Film side | 0 | 15.69 | 8.53 | 4.99 | 3.68 | 2.79 | 1.55 |
| 20 | 40 | Film side | 0 | 36.22 | 29.11 | 25.01 | 23.3 | 21.27 | 12.23 |
| 20 | 30 | Film side | 0 | 35.15 | 27.91 | 24.37 | 22.38 | 20.63 | 10.62 |
| 20 | 20 | Film side | 0 | 26.98 | 18.09 | 12.89 | 10.36 | 9.59 | 3.34 |
| 25 | 40 | Film side | 0 | 40.29 | 36.42 | 32.19 | 31.01 | 29.65 | 22.2 |
| 25 | 30 | Film side | 0 | 39.04 | 31.47 | 27.15 | 25.12 | 22.85 | 12.92 |
| 25 | 20 | Film side | 0 | 28.22 | 17.89 | 11.46 | 8.41 | 6.15 | 3.02 |

4-B-3) Anhydrous CuSO₄ with Acrylic Adhesive

Loading, Thickness Vs. Color-Change Retention:

TABLE 23
Acrylic adhesive formulations - Varied CuSO₄ loading amount

| | | CuSO₄ dry parts per 100 adhesive solid part | | | | |
|---|---|---|---|---|---|---|
| Material | Solid % | 3 | 5 | 10 | 20 | 25 |
| EXK18-052 | 50 | 10.4 | 10.4 | 10.4 | 10.4 | 10.4 |
| BXX4805TX | 5 | 0.874 | 0.874 | 0.874 | 0.874 | 0.874 |
| Toluene (Cross linker Dilution) | 0 | 2 | 2 | 2 | 2 | 2 |
| CuSO₄ | 100 | 0.156 | 0.26 | 0.52 | 1.04 | 1.3 |
| IPA | 0 | 2 | 2 | 2 | 2 | 2 |
| IPA (Rinse) | 0 | 1 | 1 | 1 | 1 | 1 |
| TiO2 | 100 | 0.26 | 0.26 | 0.26 | 0.26 | 0.26 |
| MEK | 0 | 2 | 2 | 2 | 2 | 2 |
| MEK (Rinse) | 0 | 1 | 1 | 1 | 1 | 1 |

Formulation Steps:

Anhydrous CuSO₄ (for the amount, refer to Table 23) was sonicated in IPA (2 g) for 5 minutes. TiO₂ (0.26 g) in MEK (2 g) was sonicated for 5 minutes. BXX4805TX (0.874 g) diluted with toluene (2 g) was added to the EXK18-052 adhesive (10.4 g) and mixed. Then, CuSO₄ and TiO₂ slurry were added to the adhesive and mixed. The adhesive mix was coated on a 1 mil PET film.

Loading, Thickness Vs. Color-Change Retention:

Table 24 and Table 25 show the initial color-change Δb and the Δb_{difference} for 25 parts CuSO₄, 20 parts CuSO₄, 10 parts CuSO₄, 5 parts CuSO₄, and 3 parts CuSO₄ in acrylic adhesive when exposed to ammonia (Method 2) for different adhesive thicknesses where their color was fading over time.

TABLE 24
Acrylic adhesive, CuSO₄ loading amount, adhesive thickness vs Δb color-change time by time

| | | | delta b from backing side (1 mil PET) | | | | | | |
|---|---|---|---|---|---|---|---|---|---|
| CuSO4 dry | Dry thickness | | Original | Initial | | | | | |
| parts per 100 | of adhesive | delta b | (before | (After | | | | | |
| adhesive | Target | measured | exposing to | exposing | 24 hrs | 48 hrs | 72 hrs | 96 hrs | 168 hrs |
| solid part | (micro m) | surface | ammonia) | ammonia) | after | after | after | after | after |
| 3 | 40 | Film side | −0.36 | 10.19 | 10.15 | 9.81 | 9.11 | 7.09 | 4.82 |
| 3 | 30 | Film side | −0.62 | 7.85 | 7.3 | 6.8 | 6.01 | 4.87 | 3.31 |
| 3 | 20 | Film side | −0.08 | 6.4 | 6.01 | 5.17 | 4.93 | 3.51 | 2.07 |
| 5 | 40 | Film side | −0.26 | 16.85 | 16.23 | 14.09 | 13.22 | 11.73 | 9.48 |
| 5 | 30 | Film side | −0.35 | 15.05 | 14.78 | 12.18 | 11.36 | 9.79 | 7.87 |
| 5 | 20 | Film side | −0.84 | 8.06 | 8 | 6.86 | 5.47 | 4.65 | 2.76 |
| 10 | 40 | Film side | −0.42 | 26.41 | 24.24 | 23.14 | 22.1 | 20.5 | 18.39 |
| 10 | 30 | Film side | −0.29 | 23.28 | 22.83 | 20.5 | 18.69 | 17.16 | 14.93 |
| 10 | 20 | Film side | −0.19 | 14.44 | 14.38 | 12.45 | 10.98 | 9.24 | 6.94 |
| 20 | 40 | Film side | −0.04 | 33.69 | 31.09 | 29.16 | 28.04 | 27.08 | 25.8 |
| 20 | 30 | Film side | −0.4 | 27.72 | 25.52 | 23.71 | 21.18 | 20.22 | 18.73 |
| 20 | 20 | Film side | −0.06 | 20.44 | 18.71 | 16.86 | 15.03 | 13.6 | 10.75 |
| 25 | 40 | Film side | −0.25 | 35 | 34.44 | 32.24 | 30.33 | 29.66 | 26.08 |
| 25 | 30 | Film side | −0.2 | 34.24 | 33.6 | 31.67 | 29.58 | 28.1 | 26.17 |
| 25 | 20 | Film side | −0.37 | 26.74 | 24.65 | 23.09 | 22.38 | 21.44 | 23.43 |

TABLE 25
Acrylic adhesive, CuSO₄ loading amount, adhesive thickness vs Δb difference change time by time

| | | | delta b difference | | | | | | |
|---|---|---|---|---|---|---|---|---|---|
| CuSO4 dry | | | Original | Initial | | | | | |
| parts per 100 | Dry thickness | delta b | (before | (After | | | | | |
| adhesive | of adhesive | measured | exposing to | exposing | 24 hrs | 48 hrs | 72 hrs | 96 hrs | 168 hrs |
| solid part | (micro m) | surface | ammonia) | ammonia) | after | after | after | after | after |
| 3 | 40 | Film side | — | 10.55 | 10.51 | 10.17 | 9.47 | 7.45 | 5.18 |
| 3 | 30 | Film side | — | 8.47 | 7.92 | 7.42 | 6.63 | 5.49 | 3.93 |
| 3 | 20 | Film side | — | 6.48 | 6.09 | 5.25 | 5.01 | 3.59 | 2.15 |
| 5 | 40 | Film side | — | 17.11 | 16.49 | 14.35 | 13.48 | 11.99 | 9.74 |
| 5 | 30 | Film side | — | 15.4 | 15.13 | 12.53 | 11.71 | 10.14 | 8.22 |
| 5 | 20 | Film side | — | 8.9 | 8.84 | 7.7 | 6.31 | 5.49 | 3.6 |
| 10 | 40 | Film side | — | 26.83 | 24.66 | 23.56 | 22.52 | 20.92 | 18.81 |
| 10 | 30 | Film side | — | 23.57 | 23.12 | 20.79 | 18.98 | 17.45 | 15.22 |
| 10 | 20 | Film side | — | 14.63 | 14.57 | 12.64 | 11.17 | 9.43 | 7.13 |
| 20 | 40 | Film side | — | 33.73 | 31.13 | 29.2 | 28.08 | 27.12 | 25.84 |
| 20 | 30 | Film side | — | 28.12 | 25.92 | 24.11 | 21.58 | 20.62 | 19.13 |
| 20 | 20 | Film side | — | 20.5 | 18.77 | 16.92 | 15.09 | 13.66 | 10.81 |
| 25 | 40 | Film side | — | 35.25 | 34.69 | 32.49 | 30.58 | 29.91 | 26.33 |
| 25 | 30 | Film side | — | 34.44 | 33.8 | 31.87 | 29.78 | 28.3 | 26.37 |
| 25 | 20 | Film side | — | 27.11 | 25.02 | 23.46 | 22.75 | 21.81 | 23.8 |

4-B-4) Adhesion of Anhydrous CuSO₄ Specimens

Pt-Cure Dimethyl Silicone Adhesive:

TABLE 26
Pt cure dimethyl silicone adhesive formulation to test adhesion

| | | CuSO₄ dry parts per 100 adhesive solid parts | | | | | |
|---|---|---|---|---|---|---|---|
| Material | Solid % | 3 | 5 | 10 | 20 | 25 | 50 |
| KR3700 (Silicone adhesive) | 60 | 10 | 10 | 10 | 10 | 10 | 10 |
| CAT-PT-50T | 2.5 | 0.03 | 0.03 | 0.03 | 0.03 | 0.03 | 0.03 |
| Toluene (Cat. Dilution) | 0 | 0.27 | 0.27 | 0.27 | 0.27 | 0.27 | 0.27 |
| Toluene (Cat. Dilution) | 0 | 1 | 1 | 1 | 1 | 1 | 1 |
| CuSO₄ | 100 | 0.18 | 0.3 | 0.6 | 1.2 | 1.5 | 3 |
| IPA | 0 | 3 | 3 | 3 | 3 | 3 | 3 |
| IPA (Rinse) | 0 | 1 | 1 | 1 | 1 | 1 | 1 |
| TiO₂ | 100 | 0.3 | 0.3 | 0.3 | 0.3 | 0.3 | 0.3 |
| MEK | 0 | 2 | 2 | 2 | 2 | 2 | 2 |
| MEK (Rinse) | 0 | 1 | 1 | 1 | 1 | 1 | 1 |
| Extra Toluene | 0 | 0 | 0 | 0 | 2 | 2 | 2 |

Anhydrous CuSO₄ (for the amount, refer to Table 26) was sonicated in IPA (3 g) or 5 minutes. TiO₂ (0.3 g) in MEK (2 g) was sonicated for 5 min. CAT-PT-50T (0.03 g) and toluene (1.27 g) were added to the KR3700 adhesive (10 g) and mixed. Then, CuSO₄ and TiO₂ slurry were added to the adhesive and mixed. The adhesive mix was coated on a 1 mil PET film.

Table 27 shows the adhesion test results for specimens made from anhydrous CuSO₄ in Pt-cure dimethyl silicone adhesive when the thickness was varied.

TABLE 27
Adhesion to steel (SUS 304) of Silicone adhesive
30 min. dwell time, pulling speed 300 mm/min.

| | CuSO4 dry | Dry | |
|---|---|---|---|
| | parts per | thickness | Average |
| | 100 adhesive | of adhesive | adhesion |
| adhesive | solid part | (micro m) | (N/25.4 mm) |
| KR3700 (Silicone adhesive) | 3 | 40 | 7.7 |
| KR3700 (Silicone adhesive) | 3 | 20 | 6.5 |
| KR3700 (Silicone adhesive) | 5 | 40 | 8.0 |
| KR3700 (Silicone adhesive) | 5 | 20 | 5.8 |
| KR3700 (Silicone adhesive) | 10 | 40 | 6.8 |
| KR3700 (Silicone adhesive) | 10 | 20 | 5.4 |
| KR3700 (Silicone adhesive) | 20 | 40 | 7.2 |
| KR3700 (Silicone adhesive) | 20 | 20 | 4.5 |
| KR3700 (Silicone adhesive) | 25 | 40 | 5.9 |
| KR3700 (Silicone adhesive) | 25 | 20 | 2.5 |
| KR3700 (Silicone adhesive) | 50 | 40 | 0.0 |
| KR3700 (Silicone adhesive) | 50 | 100 | 0.0 |

Acrylic Adhesive:

TABLE 28
Acrylic adhesive formulations to test adhesion

| | | CuSO₄ dry parts | | |
|---|---|---|---|---|
| | | per 100 adhesive solid parts | | |
| Material | Solid % | 0 | 15 | 50 |
| EXK18-05(Acrylic | 50 | 10.4 | 10.4 | 10.4 |
| adhesive) | | | | |
| BXX4805TX | 5 | 0.874 | 0.874 | 0.874 |
| Toluene | 0 | 2 | 2 | 2 |
| (Crosslinker Dilution) | | | | |
| CuSO₄ | 100 | 0 | 0.78 | 2.6 |
| IPA | 0 | 2 | 2 | 4 |
| IPA (Rinse) | 0 | 1 | 1 | 2 |
| TiO₂ | 100 | 0.26 | 0.26 | 0.26 |
| MEK | 0 | 2 | 2 | 2 |
| MEK (Rinse) | 0 | 1 | 1 | 1 |
| Extra Toluene | 0 | 0 | 0 | 0 |

Anhydrous CuSO₄ (for the amount, refer to Table 28) was sonicated in IPA (2 g) for 5 minutes. TiO₂ (0.26 g) in MEK (2 g) was sonicated for 5 minutes. BXX4805TX (0.874 g) diluted with toluene (2 g) was added to the EXK18-052 adhesive (10.4 g) and mixed. Then, CuSO₄ and TiO₂ slurry were added to the adhesive and mixed. The adhesive mix was coated on a 1 mil PET film.

Table 29 shows the adhesion test results for specimens made from anhydrous CuSO₄ in acrylic adhesive when the thickness was varied.

TABLE 29
Adhesion to steel (SUS 304) of acrylic adhesive
30 min. dwell time, Pulling speed 300 mm/min

| | CuSO₄ dry | Dry | |
|---|---|---|---|
| | parts per | thickness | Average |
| | 100 adhesive | of adhesive | adhesion |
| Adhesive | solid part | (□m) | (N/25.4 mm) |
| EXK18-05 (Acrylic | 15 | 60 | 9.3 |
| adhesive) | | | |
| EXK18-05 (Acrylic | 50 | 100 | 0.0 |
| adhesive) | | | |
| EXK18-05 (Acrylic | 0 | 20 | 7.4 |
| adhesive) | | | |
| EXK18-05 (Acrylic | 0 | 100 | 10.0 |
| adhesive) | | | |

4-B-5) Exposure to Anhydrous Ammonia (7.5% in Air): Anhydrous CuSO₄ 15 parts per 100 adhesive dry part in Table 20 (40 mm and 50 mm adhesive thickness) with 1 mil polyimide were exposed to anhydrous ammonia (7.5% in air) for 30 minutes at 15 mL/min flow rate and room temperature (Method 4). The ΔL_{differences} for 40 mm thick sample and 50 mm sample were measured as 19.36 and 21.2, respectively. These results show that both anhydrous ammonia and ammonium hydroxide can provide good color-change and hence be able to be detected.

4-B-6) Anhydrous CuSO₄ with Moisture Cure Silicone Rubber

S-48: Anhydrous CuSO₄ (1.5 g) and octane (1.0 g) was added to Dow Corning 734 RTV Sealant (10 g) and mixed. This mix was coated on a 2 mil polyethylene film to provide a silicone rubber layer 45 mm thick. When exposed to ammonia (Method 2), a ΔL_{difference} of 27.3 was measured between the before and after color-change. The color-change was from pale blue to dark purple for the adhesive layer. This silicone rubber S does not have tackiness after it is cured by moisture.

4-B-7) UV-Resistance of Anhydrous CuSO₄ in Pt-Cure Dimethyl Silicone Adhesive

Anhydrous CuSO₄ 20 parts per 100 adhesive dry part in table 20 (40 mm adhesive thickness) with 1 mil polyimide and 1 mil PET backing were exposed to UV in a sunshine weather-ometer (Super xenon weather meter SX-75, 7.5KW xenon arc lamp, Suga test instrument Co.) for 200 hrs & 400 hrs, 600 hrs (Table 30). UV was irradiated from the Polyimide or PET backing film side. Then, the samples were exposed to ammonia gas (Method 2). These samples did not show significant degradation of ammonia detection ability from being subjected to this accelerated UV test. Case of PET backing, film was slightly fragile.

TABLE 30
ΔL_{difference} color-change for specimens with anhydrous
CuSO₄with PI and PET backing after exposure to UV

| Sample | (PI) | (PET) |
|---|---|---|
| 0 hrs | 19.43 | 27.74 |
| 200 hrs | 27.6 | 22.55 |
| 400 hrs | 21.9 | 17.03 |
| 600 hrs | 18.93 | 18.12 |

4-B-8) Exposure to Liquid Ammonia

Anhydrous CUSO₄ 15 parts per 100 adhesive dry part in Table 20 (50 mm adhesive thickness) with 1 mil PET was soaked in 30% aqueous ammonia for 5 min. The color-change was from white to dark purple for the adhesive layer. The initial Δb_{difference} after color-change was measure as 38.75. The color-fading after 24 hrs, 48 hrs, and 72 hrs were measured as Δb_{differences} of 32.56, 28.26, and 21.43 respectively. These results show that aqueous ammonia can provide good color-change and hence be able to be detected.

### Example 5

Comparison with Other Metal Salts that can be Reacted with Ammonia.

NiCl₂ & NiSO₄ are known to react with ammonia. The samples in Table 31 were formulated in order to confirm its chemochromic property.

TABLE 31
Formulations based on nickel chloride, sulfate and
nitrate; their color-change with NH₃ and H₂S gas

| Formulation | NiCl₂ | NiSO₄ | NiNO₃ |
|---|---|---|---|
| Curing temperature (° C.) | 177 | — | 177 |
| Curing time (min) | 3 | — | 3 |
| Backing film | 1 mil | — | 1 mil |
| | polyimide | | polyimide |
| Adhesive thickness as dry | 60 | — | 60 |
| (microM) | | | |
| SilGrip ™ 518 (55.5%) (g) | 4.688 | 4.688 | 4.688 |
| BPO (g) | 0.063 | 0.063 | 0.063 |
| Toluene (g) | 0 | 0 | 0 |
| TiO₂ (g) | 0.15 | 0.15 | 0.15 |
| MEK (disperse) (g) | 1 | 1 | 1 |
| MEK (rinse) (g) | 1 | 1 | 1 |
| IPA (g) | 2.47 | 2.47 | 2.47 |
| NiCl₂ (g) | 0.13 | — | — |
| NiSO₄ (g) | — | 0.13 | — |
| NiNO₃ (g) | — | — | 0.13 |
| Color change by ammonia | No | — | No |

NiCl₂ was dispersed in IPA as 5% solution, which was then heated up to 70° C.; however, the NiCl₂ wasn't soluble in IPA. Then, at room temp., the solution was sonicated for 5 min. As result, the NiCl₂ broke down into a fine power. The powder was formulated in an adhesive and coated so as to achieve an adhesive with a thickness of 60 mm. NiSO₄ could not be dissolved in IPA, and even when sonicated, it was not able to be a fine powder. NiNO₃ was able to be dissolved in IPA as 5% solution. The NiCl₂ sample and NiNO₃ sample were exposed to 38 to 40% ammonia for 10 min. (Method 2), but the color did not change.

5. Methods Used in the Examples

Method 1—Making a Draw Down Sample

A coating machine with a glass plate is prepared. A 12″ width×14″ length film backing is placed on the clean glass plate wherein the plate is larger than the film backing. One end of the film backing is fixed on the glass temporarily with double coated adhesive tape. A draw down bar (effective width 9″, Tester Sangyo Co. LTD, Tokyo Japan) is placed on the film backing. An appropriate amount of adhesive solution is placed in front of the draw down bar, and then the dial of the coating machine is adjusted to control the gap between the film and the bar in order to get a target thickness. The bar is drawn down so as to coat the adhesive onto the film. The coated film is placed on the support plate. The film may be fixed onto the plate with clips. The coated film is air dried at room temperature for about 3 to 5 minutes, and then dried and cured at high temperature for 3 minutes.

Method 2—Exposing Adhesive Tape or Existing Products to Ammonia Gas from Aqueous Solution

Ammonium hydroxide solution (28 to 30%, Sigma Aldrich) is poured into a 500 ml Erlenmeyer flask that has about a 30 mm diameter opening at top. An adhesive tape specimen was placed over the opening so as to close the opening completely with adhesive tape. Thus, the adhesive surface is exposed to ammonia gas rising from ammonia water. The adhesive tape was left on for 10 minutes and then removed. The specimen was checked for color change by naked eye observation and/or the ΔL value was measured from the backing film side using a color meter, both before and after the tape was exposed to ammonia.

After the color of the specimen was changed by exposing to ammonia gas, the specimen was moved away from the ammonia gas to see if the color change reverted back to its original color. How long it took to revert back was measured.

In the case where the specimen was made using a clear film, a 1 mil (0.0254 mm) polyimide film was placed on its backing in order to make the color change strong via black and white contrast.

Method 3—ΔL_{difference}

A colorimeter device (Color-Tec PCM+, ColorTec, NJ, USA) was used to measure ΔL, which indicates the lightness value in CIELAB color space with L=0 representing the darkest black and L=100 representing the brightest white. The ΔL of the specimen was measured against the standard white panel (i.e., the blank) that was equipped with this device. This is the ΔL initial value. After the specimen was exposed to ammonia gas, the ΔL of the specimen was measured against the standard white panel. This is the ΔL after value. The ΔL_{difference} is calculated by subtracting ΔL initial from ΔL after to obtain the ΔL_{difference}. The higher value of ΔL_{difference} corresponds to a more intense color-change.

When the specimen was measured, the adhesive side was covered with a clear fluoro silicone PET release liner. Then, the specimen was placed on white copier paper. The ΔL value was measured from the backing film side.

In the case of polyimide backing sample, the sample was measured as is. In the case of PET backing sample, the backing PET film was covered with 1 mil polyimide film in order to enhance the color change difference in a black and white axis. If the ΔL_{difference} is larger than 5, it is easy to recognize the difference in color by the naked eye.

Method 3.2—Δb_{difference}

A colorimeter device (Color-Tec PCM+, Color-Tec, NJ, USA) was used to measure Δb, which indicates the lightness value in CIELAB color space with b<0 representing the yellowness and b>0 representing the blueness. The Δb of the specimen was measured against the standard white panel (i.e., the blank) that was equipped with this device. This is the Δb initial value. After the specimen was exposed to ammonia gas, the Δb of the specimen was measured against the standard white panel. This is the Δb after value. The Δb_{difference} is calculated by subtracting Δb initial from Δb after to obtain the Δb_{difference}. The higher value of Δb_{difference} corresponds to a more intense color-change.

When the specimen was measured, the adhesive side was covered with a clear fluoro silicone PET release liner. Then, the specimen was placed on white copier paper. The Δb value was measured from the backing film side. If the Δb_{difference} is larger than 5, it is easy to recognize the difference in color by the naked eye.

Method 4—Exposing Adhesive Tape or Existing Products to Anhydrous 7.5% Ammonia Gas

The specimen was applied on a PTFE frame that has opening of 25 mm×25 mm. This specimen with PTFE frame was placed in a 30 ml glass vial. This vial had a gas intake port and gas exhaust port. 7.5% ammonia gas at 15 ml/min at R.T. was flown into the vial for 30 minutes and then the ΔL or Δb of the specimen before and after it was exposed to ammonia was measured as same way as test Method 3 and Method 3.2.

What is claimed is:

1-25. (canceled)

26. A chemochromic indicator for detecting an ammonia compound comprising:
a. A first adhesive layer; and
b. a chemochromic copper compound, the copper compound disposed in the adhesive layer, wherein exposure to an ammonia compound changes the color of the adhesive layer.

27. A chemochromic indicator according to claim 26, wherein the ammonia compound is ammonia gas, hydrous ammonia liquid or combinations thereof.

28. A chemochromic indicator according to claim 26, wherein the adhesive layer is a pressure sensitive adhesive layer or a self-fusing adhesive layer.

29. A chemochromic indicator according to claim 28, wherein the adhesive layer is comprised of a silicone polymer, an acrylic polymer, a urethane polymer, a natural rubber, a synthetic rubber, or combinations thereof.

30. A chemochromic indicator according to claim 26, wherein the copper compound is CuSO₄, CuNO₃, CuCl₂, or Cu(CH₃COO)₂.

31. A chemochromic indicator according to claim 26, wherein the copper compound is CuSO₄ and CuCl₂.

32. A chemochromic indicator according to claim 30, wherein the copper compound is anhydrous or hydrate, or combinations thereof.

33. The chemochromic indicator according to claim 26 further comprising a contrasting color compound.

34. The chemochromic indicator of claim 33, wherein the contrasting color compound comprises titanium dioxide (TiO₂).

35. A chemochromic indicator according to claim 26, wherein the copper compound comprises CuSO₄, and the amount of CuSO₄ is equal to or higher than 5 parts per 100 of adhesive.

36. A chemochromic indicator according to claim 26, wherein the thickness of adhesive layer is equal to or higher than 30 micro m thickness.

37. A chemochromic indicator according to claim 26, wherein the copper compound comprises CuSO₄, the amount of CuSO₄ is equal to or higher than 10 parts per 100 of organic polymer or adhesive solid part and thickness of organic polymer or adhesive layer is equal to or higher than 30 micro m thickness.

38. A chemochromic indicator according to claim 26, further comprising a backing layer.

39. A chemochromic indicator according to claim 26, further comprising a release liner.

40. A chemochromic indicator according to claim 26, further comprising a second adhesive layer on top of the first adhesive layer.

41. A chemochromic indicator according to claim 26, wherein the chemochromic indicator has an adhesion higher than 0.5 N/25.4 mm.

42. A method for indicating the presence of ammonia gas comprising:
a. Contacting ammonia with the adhesive layer comprising a chemochromic indicator according to claim 26; and
b. Determining a difference between a post-exposure colorimetric state of said chemochromic indicator and a pre-exposure colorimetric state of said chemochromic indicator.

43. A method for manufacturing a chemochromic indicator comprising the steps of:
a. Dispersing hydrous or anhydrous CuSO₄ in an organic solvent to create a dispersion;
b. Sonicating the dispersion so as to create a copper slurry;
c. Adding the copper slurry to a polymer so as to create a mixture; and
d. Coating the mixture onto a backing layer or release liner for drying and curing.

44. The method of claim 43, wherein the backing layer comprises polyethylene terephthalate.

45. The method of claim 43, wherein the release liner is a fluorocarbon release liner.
